(19) United States
(12) Patent Application Publication
(10) Pub. No.: US 2025/0202589 A1
(43) Pub. Date: Jun. 19, 2025

(54) OPTICAL TRANSMITTER AND METHOD FOR CONTROLLING OPTICAL TRANSMITTER

(71) Applicant: NEC Corporation, Tokyo (JP)

(72) Inventor: Takanori SHIMIZU, Tokyo (JP)

(73) Assignee: NEC Corporation, Tokyo (JP)

(21) Appl. No.: 18/967,708

(22) Filed: Dec. 4, 2024

(30) Foreign Application Priority Data
Dec. 19, 2023 (JP) 2023-213563

(51) Int. Cl. H04B 10/50; H04B 10/572

(52) U.S. Cl. CPC H04B 10/506; H04B 10/503; H04B 10/572

(57) ABSTRACT

The optical transmitter includes: a mode-locked laser light source; a plurality of semiconductor modulators; an optical filter configured to pass light in a passband from modulated light being modulated by a first semiconductor modulator; an optical monitor configured to monitor the passed light; a wavelength controller controlling a wavelength of the light from the mode-locked laser light source, based on the monitored result; and a bias controller controlling a bias voltage of the first semiconductor modulator, based on the monitored result. The mode-locked laser light source includes a reflective semiconductor optical amplifier, an external cavity including a multiplying filter configured to multiply a longitudinal mode spacing of the mode-locked laser light source, and a multiplying filter adjustment heater configured to be able to heat the multiplying filter.

### INCORPORATION BY REFERENCE

This application is based upon and claims the benefit of priority from Japanese patent application No. 2023-213563, filed on Dec. 19, 2023, the disclosure of which is incorporated herein in its entirety by reference.

### TECHNICAL FIELD

The present disclosure relates to an optical transmitter and a method for controlling an optical transmitter.

### BACKGROUND ART

In recent years, due to spread of the Internet, 5G, and the like, research on an increase in speed and capacity has been proceeding in optical communication used as a fundamental technique. For example, an increase in capacity exceeding 100 giga bit per second (Gbps) is achieved by using a digital coherent method combining an optical phase modulation method and a polarization demultiplexing technique. As a modulator for such high speed transmission, a Mach-Zehnder modulator (MZM) is used.

Japanese Patent No. 5924349 has been known as a related technique. Japanese Patent No. 5924349 describes an LN (LiNbO₃: lithium niobate) modulator constituting an MZ modulator and a control unit that controls a bias voltage of the LN modulator.

### SUMMARY

Meanwhile, development of a semiconductor modulator in which an MZ modulator is formed on a semiconductor substrate has been proceeding, and a size reduction and power savings are expected by integrating an optical device including the semiconductor modulator in the future. However, in the related technique, integration of an optical device such as a semiconductor modulator is not taken into consideration. Thus, in the related technique, in a case where a modulator and a light source are integrated in an optical transmitter, it may be difficult to suitably perform bias control of the modulator and wavelength control of the light source.

An example object of the present disclosure is, in view of such a problem, to provide an optical transmitter and a method for controlling an optical transmitter that are able to suitably perform bias control of a modulator and wavelength control of a light source.

In a first aspect of the present disclosure, an optical transmitter includes: a mode-locked laser light source configured to generate a multiwavelength light; a plurality of semiconductor modulators configured to modulate, for each wavelength, the generated multiwavelength light from the mode-locked laser light source into modulated light; an optical filter configured to pass light in a passband from modulated light being modulated by a first semiconductor modulator among the plurality of semiconductor modulators; an optical monitor configured to monitor the passed light; a wavelength control means for controlling a wavelength of the multiwavelength light from the mode-locked laser light source, based on the monitored result; and a bias control means for controlling a bias voltage of the first semiconductor modulator, based on the monitoring result, wherein the mode-locked laser light source includes a reflective semiconductor optical amplifier configured to emit light, an external cavity being configured to circulate light from the reflective semiconductor optical amplifier, and including a multiplying filter configured to multiply a longitudinal mode spacing of the mode-locked laser light source, and a multiplying filter adjustment heater configured to be able to heat the multiplying filter, and the wavelength control means controls a wavelength of the multiwavelength light from the mode-locked laser light source by controlling a heater current injected into the multiplying filter adjustment heater.

In a second aspect of the present disclosure, a method for controlling an optical transmitter includes: generating a multiwavelength light by a mode-locked laser light source; modulating, for each wavelength, the generated multiwavelength light from the mode-locked laser light source into modulated light by a plurality of semiconductor modulators; passing light in a passband from modulated light being modulated by a first semiconductor modulator among the plurality of semiconductor modulators; monitoring the passed light; controlling a wavelength of the multiwavelength light from the mode-locked laser light source, based on the monitored result; controlling a bias voltage of the first semiconductor modulator, based on the monitored result; in the mode-locked laser light source, emitting light by a reflective semiconductor optical amplifier; and in an external cavity configured to circulate light from the reflective semiconductor optical amplifier, multiplying a longitudinal mode spacing of the mode-locked laser light source by a multiplying filter, wherein controlling the wavelength includes controlling a wavelength of the multiwavelength light from the mode-locked laser light source by controlling a heater current injected into a multiplying filter adjustment heater configured to be able to heat the multiplying filter.

According to the present disclosure, bias control of a modulator and wavelength control of a light source can be suitably performed.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a configuration diagram illustrating a configuration of an optical transmitter in a related technique;

FIG. 2 is a schematic side view illustrating an arrangement example of a temperature adjustment function of a light source in the related technique;

FIG. 3 is a configuration diagram illustrating a configuration example of an optical transmitter according to some example embodiments;

FIG. 4 is a configuration diagram illustrating a configuration example of the optical transmitter according to some example embodiments;

FIG. 5 is a configuration diagram illustrating a configuration example of the optical transmitter according to some example embodiments;

FIG. 6 is a schematic side view illustrating one example of an arrangement of each unit in a semiconductor substrate according to some example embodiments;

FIG. 7 is a schematic side view illustrating another example of an arrangement of each unit in the semiconductor substrate according to some example embodiments;

FIG. 8 is a configuration diagram illustrating a specific configuration example of a semiconductor modulator according to some example embodiments;

FIG. 9 is a flowchart illustrating an operation example of the optical transmitter according to some example embodiments;

FIG. 10A is a diagram illustrating an example of a spectrum for describing a specific example of wavelength control of a light source according to some example embodiments;

FIG. 10B is a diagram illustrating an example of monitoring power for describing a specific example of wavelength control of the light source according to some example embodiments;

FIG. 11A is a diagram illustrating an example of a spectrum for describing a specific example of wavelength control of the light source according to some example embodiments;

FIG. 11B is a diagram illustrating an example of monitoring power for describing a specific example of wavelength control of the light source according to some example embodiments;

FIG. 12A is a diagram illustrating an example of a spectrum for describing a specific example of wavelength control of the light source according to some example embodiments;

FIG. 12B is a diagram illustrating an example of monitoring power for describing a specific example of wavelength control of the light source according to some example embodiments;

FIG. 13 is a flowchart illustrating a detailed operation example of wavelength control processing of a single wavelength light source according to some example embodiments;

FIG. 14A is a diagram illustrating an example of monitoring power for describing the wavelength control processing of the single light source according to some example embodiments;

FIG. 14B is a diagram illustrating an example of monitoring power for describing the wavelength control processing of the single light source according to some example embodiments;

FIG. 14C is a diagram illustrating an example of monitoring power for describing the wavelength control processing of the single light source according to some example embodiments;

FIG. 15 is a flowchart illustrating a detailed operation example of bias control processing of the semiconductor modulator according to some example embodiments;

FIG. 16A is a diagram illustrating an example of an objective function value for describing the bias control processing of the semiconductor modulator according to some example embodiments;

FIG. 16B is a diagram illustrating an example of an objective function value for describing the bias control processing of the semiconductor modulator according to some example embodiments;

FIG. 16C is a diagram illustrating an example of an objective function value for describing the bias control processing of the semiconductor modulator according to some example embodiments;

FIG. 17 is a configuration diagram illustrating a configuration example of the optical transmitter according to some example embodiments;

FIG. 18 is a diagram illustrating an example of a passband of a band-pass optical filter according to some example embodiments;

FIG. 19 is a flowchart illustrating an operation example of the optical transmitter according to some example embodiments;

FIG. 20 is a configuration diagram illustrating a configuration example of the optical transmitter according to some example embodiments;

FIG. 21 is a configuration diagram illustrating a specific configuration example of a Dual polarization (DP)-IQ modulator according to some example embodiments;

FIG. 22 is a configuration diagram illustrating a configuration example of the optical transmitter according to some example embodiments;

FIG. 23 is a configuration diagram illustrating a configuration example of the optical transmitter according to some example embodiments;

FIG. 24 is a schematic top view illustrating a configuration example of a multiwavelength light source according to some example embodiments;

FIG. 25 is a schematic side view illustrating an arrangement example of each unit in the semiconductor substrate according to some example embodiments;

FIG. 26 is a flowchart illustrating an operation example of the optical transmitter according to some example embodiments;

FIG. 27A is a diagram illustrating an example of a spectrum for describing an operation example of the optical transmitter according to some example embodiments;

FIG. 27B is a diagram illustrating an example of a spectrum for describing an operation example of the optical transmitter according to some example embodiments;

FIG. 27C is a diagram illustrating an example of a spectrum for describing an operation example of the optical transmitter according to some example embodiments; and

FIG. 28 is a configuration diagram illustrating a configuration example of hardware of a computer according to some example embodiments.

### EXAMPLE EMBODIMENT

Example embodiments will be described below with reference to the drawings. In each of the drawings, the same or corresponding elements will be denoted by the same reference signs, and repeated description will be omitted depending on need for the sake of clarity of description. Note that an arrow indicated in each drawing is an exemplification for description, and does not limit a kind and a direction of a signal.

### (Consideration of Related Technique)

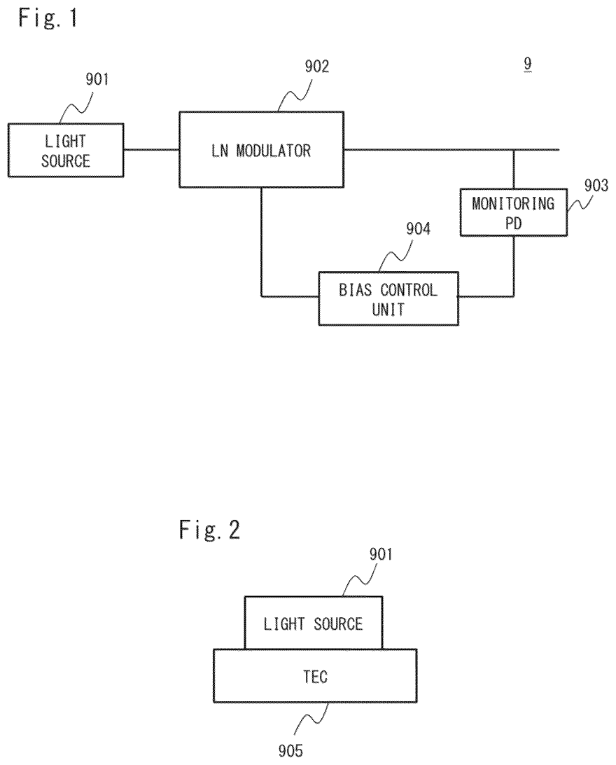

First, a related technique will be considered. FIG. 1 illustrates a configuration of an optical transmitter 9 in the related technique, based on the description in Japanese Patent No. 5924349, for example. FIG. 1 is a configuration example of an optical transmitter using an LN modulator. As illustrated in FIG. 1, the related optical transmitter 9 includes a light source 901, an LN modulator 902, a monitoring PD 903, and a bias control unit 904.

The light source 901 is an external light source provided outside the LN modulator 902, and is connected to the LN modulator 902 via an optical fiber and the like. The light source 901 is, for example, a distributed feedback (DFB) laser. The LN modulator 902 modulates light output from the light source 901. The monitoring PD 903 is a light receiving unit provided outside the LN modulator 902. The light modulated by the LN modulator 902 is received and monitored by the monitoring PD 903. The bias control unit 904 performs feedback control on a bias voltage of the LN modulator 902 in such a way as to reduce an output deviation due to bias point (operation point) shift of the LN modulator 902 according to a monitoring result of the monitoring PD 903.

Further, light output from a light source has a wavelength shift due to aged deterioration and the like, and thus wavelength control needs to be performed in such a way that light with a desired wavelength is output from the light source. As a related technique, a wavelength control method using a temperature adjustment function is considered. FIG. 2 is a schematic side view illustrating an arrangement example of a temperature adjustment function of a light source in the related technique. As illustrated in FIG. 2, in the related technique, a thermoelectric cooler (TEC) 905 as the temperature adjustment function is disposed below the external light source 901. A wavelength of the light source 901 is controlled by adjusting a temperature of an entire surface of a lower portion of the light source 901 by the TEC 905.

However, in a related optical transmitter, a light source is external to an LN modulator, and a temperature adjustment function of the light source is large, which is an obstacle to a size reduction. Further, if an LN modulator is used as a semiconductor modulator, and the semiconductor modulator and a light source are integrated, it is difficult to locally perform wavelength control on the light source with a large temperature adjustment function such as a TEC. Thus, in example embodiments, wavelength control of a light source and bias control of a semiconductor modulator can be brought close and performed in a smaller area.

### OVERVIEW OF EXAMPLE EMBODIMENTS

First, an overview of the example embodiments will be described. Note that the overview of the example embodiments is described herein, but the example embodiments may be implemented as one example embodiment.

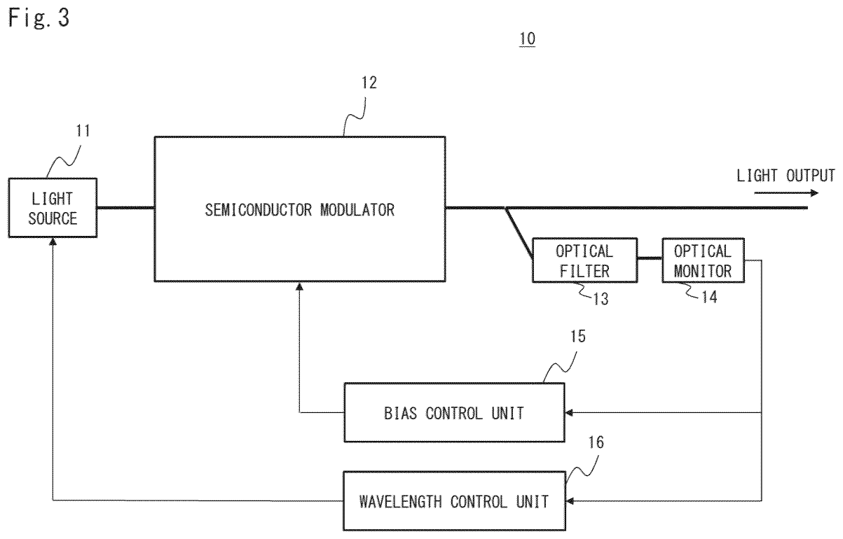

FIG. 3 illustrates a configuration example of an optical transmitter 10 according to some example embodiments. The optical transmitter 10 is, for example, an optical transmitter for digital coherent communication. In the example in FIG. 3, the optical transmitter 10 includes a light source 11, a semiconductor modulator 12, an optical filter 13, an optical monitor 14, a bias control unit 15, and a wavelength control unit 16. For example, the light source 11 and the semiconductor modulator 12 may be formed on the same semiconductor substrate. Further, the light source 11, the semiconductor modulator 12, the optical filter 13, and the optical monitor 14 may be formed on the same semiconductor substrate.

The light source 11 generates and outputs light. The light source 11 is a semiconductor laser such as a DFB laser, for example. The light source 11 may be a single wavelength light source that generates a single wavelength light, or may be a multiwavelength light source that generates a multiwavelength light.

The semiconductor modulator 12 modulates the light generated by the light source 11, and outputs modulated light being modulated. The semiconductor modulator 12 is, for example, an in-phase and quadrature (IQ) modulator.

The optical filter 13 passes light in a passband from the modulated light being modulated by the semiconductor modulator 12. The optical filter 13 is, for example, a semiconductor optical band-pass filter (BPF). The modulated light being modulated by the semiconductor modulator 12 may be branched into an output optical signal for output and a monitoring optical signal for monitoring by a demultiplexer (branch unit), and the optical filter 13 may pass the branched monitoring optical signal.

The optical monitor 14 monitors the light passing through the optical filter 13, and outputs a monitored result. The optical monitor 14 is, for example, a semiconductor photo detector (PD).

The wavelength control unit 16 controls a wavelength of the light generated by the light source 11, based on a result passing through the optical filter 13 and being monitored by the optical monitor 14. For example, a heater that can heat the light source 11 may be provided, and the wavelength control unit 16 may control a heat generation amount of the heater according to a monitoring result of the optical monitor 14. The wavelength control unit 16 may control a wavelength of the light from the light source 11 by controlling a heater current being injected (supplied) into the heater.

For example, the wavelength control unit 16 may control a heater current in a case where power of light monitored by the optical monitor 14 is decreased from an initial value by equal to or more than a predetermined designated value. The initial value is power of light being initially set in a state where a wavelength of the light from the light source 11 is not deviated. For example, the wavelength control unit 16 may increase and decrease a heater current by a fixed amount in a case where power of light monitored by the optical monitor 14 is decreased from an initial value by equal to or more than a predetermined designated value, and may control the heater current according to a shift amount of the power of the monitored light when the heater current is increased and decreased. In this case, the wavelength control unit 16 controls the heater current according to an inclination of shift in the power of the light with respect to the increase and the decrease in the heater current. In other words, the wavelength control unit 16 may control the heater current according to an increase or a decrease in the power of the monitored light when the heater current is increased, and an increase or a decrease in the power of the monitored light when the heater current is decreased.

The bias control unit 15 controls a bias voltage of the semiconductor modulator 12, based on a result passing through the optical filter 13 and being monitored by the optical monitor 14. The bias control unit 15 may control a bias voltage, based on power of light monitored by the optical monitor 14, or may control a bias voltage, based on a function value converted from power of light monitored by the optical monitor 14 by a predetermined function. The predetermined function is an objective function for bias control.

For example, the bias control unit 15 may control a bias voltage in a case where a function value based on power of light monitored by the optical monitor 14 is increased from an initial value by equal to or more than a predetermined designated value. The initial value is a bias voltage being initially set in a state where a bias point (operation point) of the semiconductor modulator 12 is not deviated. For example, the bias control unit 15 may increase and decrease a bias voltage in a case where a function value based on power of light monitored by the optical monitor 14 is increased from an initial value by equal to or more than a predetermined designated value, and may control the bias voltage according to a shift amount of the function value based on the power of the monitored light when the bias voltage is increased and decreased. In this case, the bias control unit 15 controls the bias voltage according to an inclination of the function value with respect to the increase and the decrease in the bias voltage. In other words, the bias control unit 15 may control the bias voltage according to an increase or a decrease in the function value based on the power of the monitored light when the bias voltage is increased, and an increase or a decrease in the function value based on the power of the monitored light when the bias voltage is decreased.

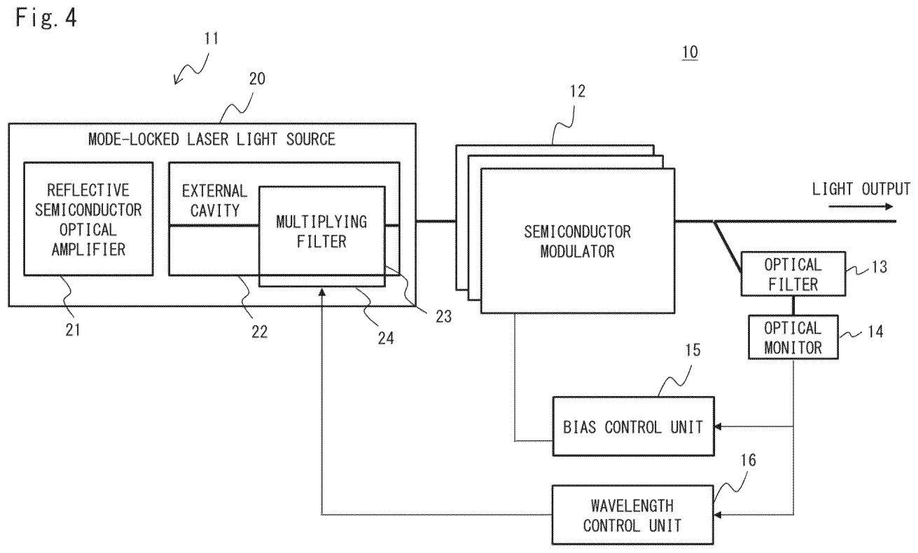

FIG. 4 is a configuration example of the optical transmitter 10 according to some example embodiments, and illustrates a configuration example in a case where the light source 11 is a multiwavelength light source.

In the example in FIG. 4, the light source 11 is a mode-locked laser light source 20. The light source 11 is not limited to the mode-locked laser light source 20, and may be other multiwavelength light sources. In a case where the light source 11 is a multiwavelength light source, the optical transmitter 10 includes a plurality of the semiconductor modulators 12. The plurality of semiconductor modulators 12 modulate, for each wavelength, a multiwavelength light being generated by the multiwavelength light source into modulated light. The optical filter 13 passes light in a passband from the modulated light being modulated by a first semiconductor modulator of the plurality of semiconductor modulators 12. The wavelength control unit 16 controls a wavelength of the light from the multiwavelength light source, based on a result monitored by the optical monitor 14 from the first semiconductor modulator through the optical filter 13. The bias control unit 15 controls a bias voltage of the first semiconductor modulator, based on a result monitored by the optical monitor 14 from the first semiconductor modulator through the optical filter 13.

In the example in FIG. 4, the mode-locked laser light source 20 includes a reflective semiconductor optical amplifier 21 that emits light, and an external cavity 22 that circulates light from the reflective semiconductor optical amplifier 21. The external cavity 22 includes a multiplying filter 23 that multiplies a longitudinal mode spacing of the mode-locked laser light source 20. Furthermore, a multiplying filter adjustment heater 24 that can heat the multiplying filter 23 may be disposed in the external cavity 22. In this case, the wavelength control unit 16 controls a wavelength of light from the mode-locked laser light source 20 by controlling a heater current injected into the multiplying filter adjustment heater 24.

Further, the external cavity 22 may include a cavity length adjustment optical waveguide that adjusts a cavity length including the reflective semiconductor optical amplifier 21 and the external cavity 22. A cavity length adjustment heater that can heat the cavity length adjustment optical waveguide may be disposed in the external cavity 22. In this case, the wavelength control unit 16 may control a wavelength of light from the mode-locked laser light source 20 by controlling a heater current injected into the multiplying filter adjustment heater 24 and the cavity length adjustment heater. For example, the multiplying filter 23 may be a ring resonator filter, and the wavelength control unit 16 may control a heater current injected into the multiplying filter adjustment heater 24 and the cavity length adjustment heater in such a way that a circulating length of the multiplying filter 23 is an integral fraction of a cavity circulating length including the reflective semiconductor optical amplifier 21 and the external cavity 22. The cavity circulating length is a circulating length (optical length) when light circulates in a cavity.

As described above, in the example embodiment, the optical filter that passes light monitored by the optical monitor for wavelength control and bias control is disposed in front of the optical monitor in the optical transmitter. In this way, wavelength control and bias control can be suitably performed by one optical monitor. Further, by forming the light source, the semiconductor modulator, and the like on the same semiconductor substrate, a size and consumption power of the optical transmitter can be reduced, and wavelength control of the light source and bias control of the semiconductor modulator can be brought close and performed in a smaller area. Furthermore, in a case where the light source is a multiwavelength light source such as a mode-locked laser, a wavelength deviation of multiwavelength light can be collectively adjusted by controlling a heater current injected into a heater disposed in the multiwavelength light source.

### First Example Embodiment

Next, a first example embodiment will be described. In the present example embodiment, an example in which wavelength control and bias control are performed in an optical transmitter including a single wavelength light source and a semiconductor modulator.

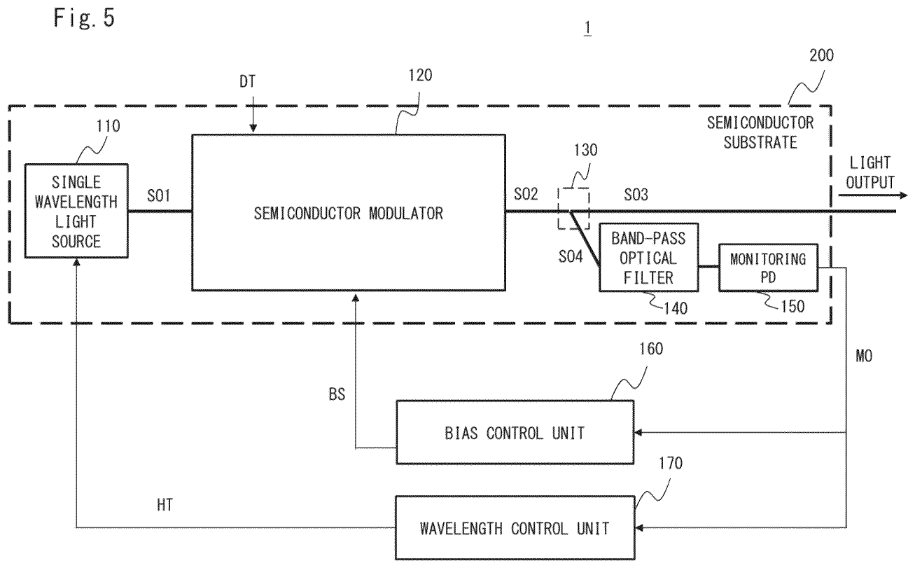

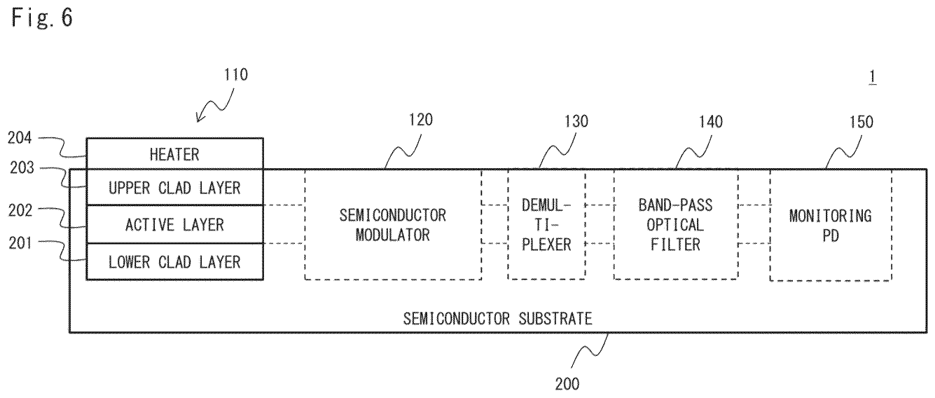

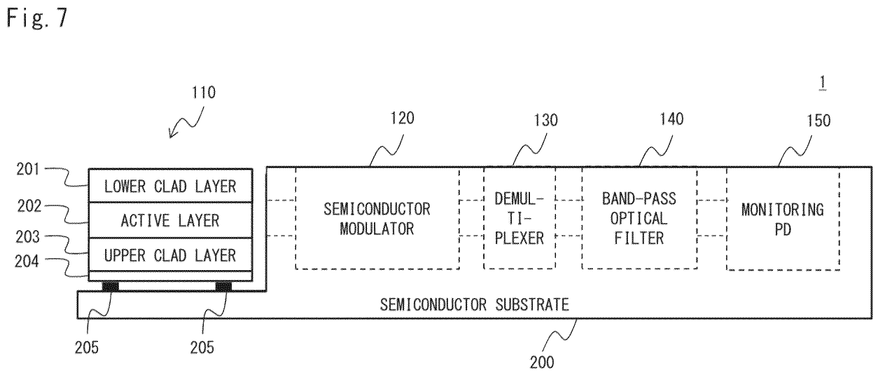

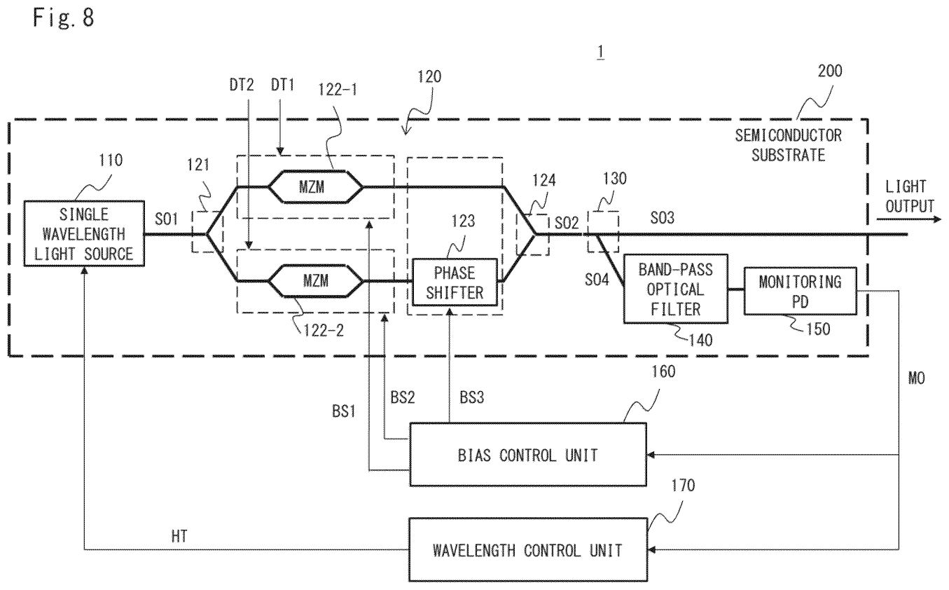

FIG. 5 illustrates a configuration example of an optical transmitter 1 according to some example embodiments. FIGS. 6 and 7 are schematic side views illustrating an arrangement example of each unit of a semiconductor substrate 200 according to some example embodiments. FIG. 8 illustrates a specific configuration example of a semiconductor modulator 120 according to some example embodiments.

The optical transmitter 1 according to the present example embodiment is, for example, an optical transmitter for digital coherent communication. In the example in FIG. 5, the optical transmitter 1 includes a single wavelength light source 110, the semiconductor modulator 120, a demultiplexer 130, a band-pass optical filter 140, a monitoring PD 150, a bias control unit 160, and a wavelength control unit 170.

For example, the single wavelength light source 110, the semiconductor modulator 120, the demultiplexer 130, the band-pass optical filter 140, and the monitoring PD 150 are formed on one semiconductor substrate 200. At least the single wavelength light source 110 and the semiconductor modulator 120 may be formed on the semiconductor substrate 200. The semiconductor substrate 200 is, for example, a semiconductor substrate of indium phosphide (InP), gallium arsenide (GaAs), silicon (Si), and the like, but other semiconductor substrates of germanium (Ge) and the like may be used.

The bias control unit 160 and the wavelength control unit 170 are formed as a semiconductor chip separately from the semiconductor substrate 200. The bias control unit 160 and the wavelength control unit 170 may be formed of separate semiconductor chips or may be formed of one semiconductor chip. The bias control unit 160 and the wavelength control unit 170 may be formed of hardware, software, or both of hardware and software. The functions of the bias control unit 160 and the wavelength control unit 170 may be implemented by executing a program stored in a memory in a processor such as a central processing unit (CPU). For example, a semiconductor chip including the bias control unit 160 and the wavelength control unit 170 may be mounted on the semiconductor substrate 200 by a flip chip method and the like. A semiconductor apparatus including all of the configurations in FIG. 5 may be one semiconductor package.

The single wavelength light source 110 generates light SO1 being light with a preset single wavelength (set wavelength). The single wavelength light source 110 is a semiconductor laser formed on the semiconductor substrate 200 of indium phosphide, silicon, and the like. For example, the single wavelength light source 110 may be a DFB laser or a distributed bragg reflector (DBR) laser, or may be an external cavity laser (ECL). The single wavelength light source 110 is a wavelength-fixed light source in which a set wavelength of the light SO1 is fixed, but may be a wavelength tunable light source in which a set wavelength of the light SO1 is tunable.

FIG. 6 illustrates one example in which the single wavelength light source 110 is integrated on the semiconductor substrate 200. In the example in FIG. 6, the single wavelength light source 110 is formed of, for example, a lower clad layer 201, an active layer 202, and an upper clad layer 203 multi-layered on the semiconductor substrate 200. Further, a heater 204 is formed in a highest position in the single wavelength light source 110 (semiconductor substrate 200), i.e., on the upper clad layer 203. The heater 204 is a heat generator that can heat the single wavelength light source 110. The heater 204 is formed of a resistor that can control a temperature, such as a TiN heater. The heater 204 is formed in association with a formation region of the single wavelength light source 110 in the semiconductor substrate 200. For example, the heater 204 may be formed within a range of the formation region of the single wavelength light source 110. The heater 204 may have the same shape and the same size as the formation region (active layer 202) of the single wavelength light source 110 in a plan view, and may have a shape and a size smaller than the formation region of the single wavelength light source 110. The heater 204 may be larger than the formation region of the single wavelength light source 110, but it is preferable that the heater 204 does not overlap a formation region of another optical device such as the semiconductor modulator 120. The heater 204 generates heat according to a heater current HT supplied from the wavelength control unit 170, an energy gap of the active layer 202 is reduced by the heat of the heater 204, a center wavelength is shifted to a long wavelength side, and thus a wavelength of the light SO1 generated in the active layer 202 is controlled. As long as a temperature of the active layer 202 can be adjusted, the heater 204 is not limited to be located on the upper clad layer 203, and may be located in the upper clad layer 203, under the lower clad layer 201, or under the semiconductor substrate 200. In a case where the single wavelength light source 110 is an external cavity laser, a wavelength may be controlled by forming a heater in a silicon waveguide constituting the external cavity laser, and adjusting a refractive index of the silicon waveguide by heat of the formed heater.

FIG. 7 illustrates another example in which the single wavelength light source 110 is mounted on the semiconductor substrate 200. In the example in FIG. 7, a semiconductor chip of the single wavelength light source 110 is mounted on the semiconductor substrate 200 by a flip chip method. In other words, the single wavelength light source 110 may be integrated on the semiconductor substrate 200 in a monolithic manner as in FIG. 6, or the single wavelength light source 110 may be integrated on the semiconductor substrate 200 in a hybrid manner as in FIG. 7. In the example in FIG. 7, the single wavelength light source 110 is mounted on the semiconductor substrate 200 by bonding the heater 204 (in a lowest position in FIG. 7) formed in the single wavelength light source 110 and the semiconductor substrate 200 via a solder bump 205.

The semiconductor modulator 120 is an IQ modulator for digital coherent communication. The semiconductor modulator 120 is a semiconductor modulator formed on the semiconductor substrate 200 of indium phosphide, silicon, and the like. The semiconductor modulator 120 modulates the light SO1 output from the single wavelength light source 110 into a modulated optical signal SO2. The semiconductor modulator 120 performs IQ modulation (coherent modulation) on the light SO1 output from the single wavelength light source 110, and outputs the modulated optical signal SO2.

In the example in FIG. 8, the semiconductor modulator 120 is formed of an MZ interferometer including two MZ modulators. The semiconductor modulator 120 includes a demultiplexer 121, MZ modulators 122-1 and 122-2, a phase shifter 123, and a multiplexer 124. The demultiplexer 121 branches (demultiplexes) the light SO1 from the single wavelength light source 110 into light for Ich (in-phase component) and light for Qch (quadrature component).

The MZ modulator 122-1 is, for example, a modulator for Ich. A data signal DT1 for Ich being generated from a transmission data signal is applied as a driving signal to the MZ modulator 122-1. The MZ modulator 122-1 modulates, according to the data signal DT1, the light for Ich being branched by the demultiplexer 121. A bias voltage BS1 that adjusts a bias point is applied to the MZ modulator 122-1 from the bias control unit 160.

The MZ modulator 122-2 is, for example, a modulator for Qch. A data signal DT2 for Qch being generated from a transmission data signal is applied as a driving signal to the MZ modulator 122-2. The MZ modulator 122-2 modulates, according to the data signal DT2, the light for Qch being branched by the demultiplexer 121. A bias voltage BS2 that adjusts a bias point is applied to the MZ modulator 122-2 from the bias control unit 160.

The phase shifter 123 shifts a phase of an optical signal of Ich or a phase of an optical signal of Qch in such a way that the phase of the optical signal of Ich and the phase of the optical signal of Qch are orthogonal to each other. In this example, the phase shifter 123 shifts, by π/2, a phase of a modulated optical signal of Qch being modulated by the MZ modulator 122-2. The phase shifter 123 may be formed of an MZ interferometer similarly to the MZ modulator, or may be configured to shift a phase by changing a refractive index of a waveguide. Further, a bias voltage BS3 that adjusts a phase shift amount is applied to the phase shifter 123 from the bias control unit 160. In a case where the phase shifter 123 is formed of an MZ interferometer, a phase shift amount may be controlled by the bias voltage BS3 applied to the MZ interferometer. A phase shift amount may be controlled by forming a heater in a waveguide constituting the phase shifter 123, and changing a refractive index of the waveguide by heat generated by applying the bias voltage BS3 to the formed heater.

The multiplexer 124 multiplexes the optical signal modulated by the MZ modulator 122-1 and the optical signal modulated by the MZ modulator 122-2 and subjected to phase shift by the phase shifter 123, and outputs the modulated optical signal SO2 being multiplexed.

The demultiplexer 130 branches the modulated optical signal SO2 generated by the semiconductor modulator 120 (IQ modulator) into an output optical signal SO3 for output and a monitoring optical signal SO4 for monitoring. The branched output optical signal SO3 is output as transmission light to the outside (such as an optical transmission path). Note that the multiplexer 124 and the demultiplexer 130 of the semiconductor modulator 120 may be one optical coupler (2×2 optical coupler).

The band-pass optical filter 140 is an optical band-pass filter (BPF) that passes an optical signal in a predetermined passband. The band-pass optical filter 140 inputs the monitoring optical signal SO4 branched by the demultiplexer 130, and passes light in a passband of the monitoring optical signal SO4. The band-pass optical filter 140 is a semiconductor filter formed on the semiconductor substrate 200 of indium phosphide, silicon, and the like. The band-pass optical filter 140 is formed of, for example, an asymmetric MZ interferometer. The band-pass optical filter 140 may be formed of a ring resonator, or may be formed of a cavity by using facing mirrors.

A passband of the band-pass optical filter 140 is associated with a set wavelength (desired target wavelength) of the light SO1 output from the single wavelength light source 110. In a case where the single wavelength light source 110 is a wavelength tunable light source, the band-pass optical filter 140 may be a band tunable filter, and a passband of the band-pass optical filter 140 may be adjusted in response to a change in a set wavelength of the light SO1 from the single wavelength light source 110. In a case where the band-pass optical filter 140 is formed of a cavity, a passband of the band-pass optical filter may be controlled by forming a heater in a waveguide of the cavity, and adjusting heat of the formed heater. Further, a plurality of band-pass optical filters having different passbands may be provided, and the band-pass optical filter to be used may be switched according to a set wavelength of the light SO1 from the single wavelength light source 110.

The monitoring PD 150 is a photo detector (PD) that monitors (detects) an optical signal passing through the band-pass optical filter 140. The monitoring PD 150 is a semiconductor PD formed on the semiconductor substrate 200 of indium phosphide, silicon, and the like. The monitoring PD 150 performs photoelectric conversion on the optical signal passing through the band-pass optical filter 140, and outputs a monitoring signal MO subjected to photoelectric conversion.

The bias control unit 160 controls the bias voltage BS of the semiconductor modulator 120, based on the monitoring signal MO being a monitoring result of the monitoring PD 150. A bias voltage of the semiconductor modulator 120 is automatically optimized by branching modulated light output from the semiconductor modulator 120, and performing feedback control on the bias voltage according to a monitoring result of the branched light. In this example, the bias control unit 160 controls each of the bias voltage BS1 applied to the MZ modulator 122-1, the bias voltage BS2 applied to the MZ modulator 122-2, and the bias voltage BS3 applied to the phase shifter 123, based on the monitoring signal MO.

The wavelength control unit 170 controls a wavelength of the light SO1 of the single wavelength light source 110, based on the monitoring signal MO being a monitoring result of the monitoring PD 150. The wavelength control unit 170 controls a heat generation amount of the heater 204 according to the monitoring result of the monitoring PD 150. The wavelength control unit 170 generates the heater current HT in response to the monitoring signal MO, and supplies the generated heater current HT to the single wavelength light source 110. For example, a wavelength of the light SO1 of the single wavelength light source 110 is controlled by injecting the heater current HT through a resistor, applying a voltage according to the heater current HT to the heater 204 via the resistor, and generating heat in the heater 204. Note that the wavelength control unit 170 may adjust a wavelength of the light SO1 by controlling a driving current that drives the single wavelength light source 110. In other words, the wavelength control unit 170 may control a driving current that drives the single wavelength light source 110 according to a monitoring result of the monitoring PD 150. In that case, power of the light SO1 output from the single wavelength light source 110 changes, and thus an optical amplifier that adjusts the power of the light SO1 may be provided.

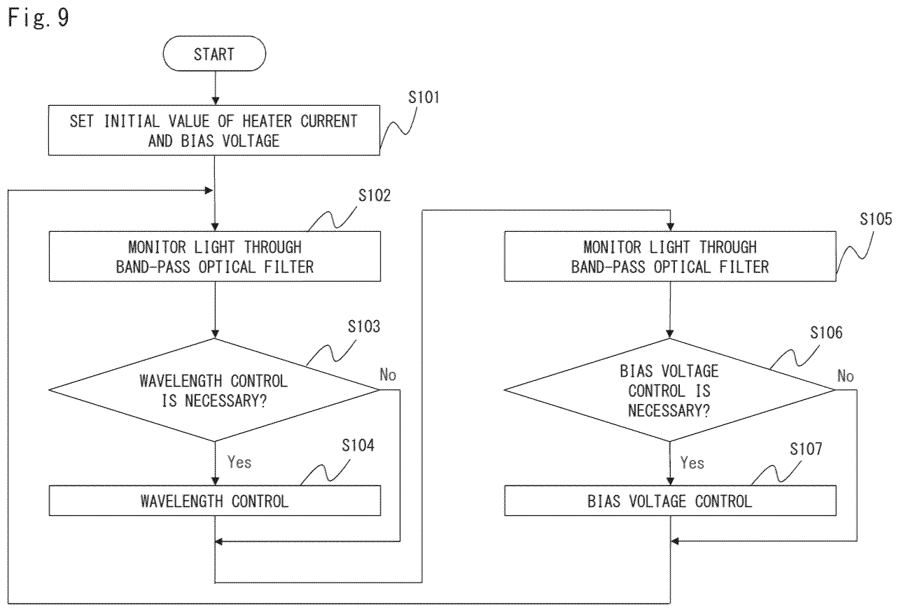

FIG. 9 illustrates an operation example of the optical transmitter 1 according to some example embodiments. In the example in FIG. 9, first, the optical transmitter 1 sets an initial value of the heater current HT of the single wavelength light source 110 and the bias voltage BS of the semiconductor modulator 120 (S101). The wavelength control unit 170 generates the heater current HT having the predetermined initial value, and supplies the generated heater current HT to the single wavelength light source 110. Specifically, the wavelength control unit 170 applies a voltage according to the heater current HT having the initial value to the heater 204 via a resistor. The single wavelength light source 110 generates the light SO1 with a wavelength set by the heater current HT having the initial value.

Further, the bias control unit 160 generates the bias voltage BS having the predetermined initial value, and supplies the generated bias voltage BS to the semiconductor modulator 120. Specifically, the bias control unit 160 applies the bias voltage BS1 having the initial value to the MZ modulator 122-1, applies the bias voltage BS2 having the initial value to the MZ modulator 122-2, and applies the bias voltage BS3 having the initial value to the phase shifter 123. The semiconductor modulator 120 performs a modulation operation at a bias point set by the bias voltage BS having the initial value.

Next, the optical transmitter 1 performs wavelength control processing of the single wavelength light source 110 (S102 to S104). In the wavelength control processing, the monitoring PD 150 monitors light through the band-pass optical filter 140 (S102). Specifically, when the semiconductor modulator 120 receives an input of the light SO1 from the single wavelength light source 110 and an input of the data signal DT, the semiconductor modulator 120 modulates the light SO1 according to the data signal DT, and outputs the modulated optical signal SO2. The demultiplexer 130 branches the generated modulated optical signal SO2 into the output optical signal SO3 and the monitoring optical signal SO4. The band-pass optical filter 140 passes light in a passband of the branched monitoring optical signal SO4. The monitoring PD 150 detects an optical signal through the band-pass optical filter 140, and converts the detected optical signal into a monitoring current (monitoring signal MO).

Next, the wavelength control unit 170 determines whether wavelength control (adjustment) of the single wavelength light source 110 is necessary, based on a monitoring result of the monitoring PD 150 (S103). For example, the wavelength control unit 170 determines whether the monitoring current (monitoring signal MO) output from the monitoring PD 150 is equal to or less than a predetermined threshold value, and determines wavelength control necessary in a case where the monitoring current is equal to or less than the predetermined threshold value.

Next, in a case where wavelength control is determined necessary, the wavelength control unit 170 controls (adjusts) a wavelength of the single wavelength light source 110 (S104). The wavelength control unit 170 adjusts the heater current HT according to the detected monitoring current, and supplies the adjusted heater current HT to the single wavelength light source 110. For example, the wavelength control unit 170 repeats adjustment to the heater current HT until the monitoring current exceeds the predetermined threshold value.

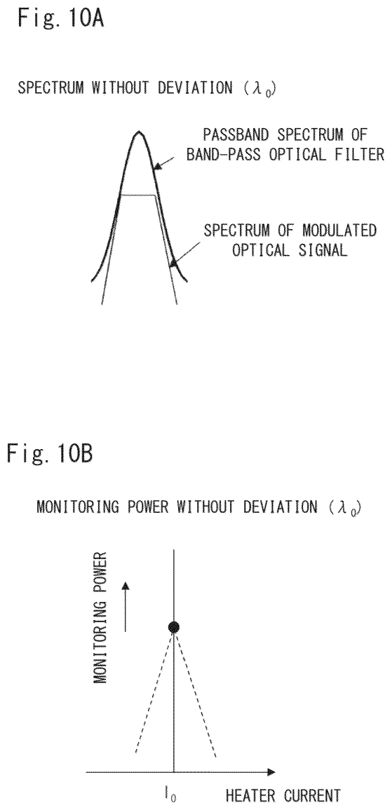

FIGS. 10A and 10B to FIGS. 12A and 12B illustrate specific examples of wavelength control of the single wavelength light source 110. FIGS. 10A and 10B illustrate examples of a spectrum and monitoring power in a case where a wavelength of the light SO1 output from the single wavelength light source 110 is not deviated from a set wavelength (λ0). In this case, as illustrated in FIG. 10A, spectra of the modulated optical signal SO2 generated by the semiconductor modulator 120 and the monitoring optical signal SO4 branched from the demultiplexer 130 are included in a passband spectrum of the band-pass optical filter 140. A bandwidth of the passband spectrum of the band-pass optical filter 140 is associated with a bandwidth of the modulated optical signal SO2 output from the semiconductor modulator 120. For example, a bandwidth of a passband of the band-pass optical filter 140 is wider than a bandwidth of the modulated optical signal SO2 or substantially the same width as a bandwidth of the modulated optical signal SO2, and is a bandwidth that can pass at least the modulated optical signal SO2. Then, as illustrated in FIG. 10B, in a case where a wavelength of the light SO1 is not deviated from the set wavelength (λ0), monitoring power (monitoring current) of the monitoring optical signal SO4 passing through the band-pass optical filter 140 has a maximum value. For example, since the monitoring power is greater than the predetermined threshold value, the wavelength control unit 170 determines wavelength control unnecessary (S103).

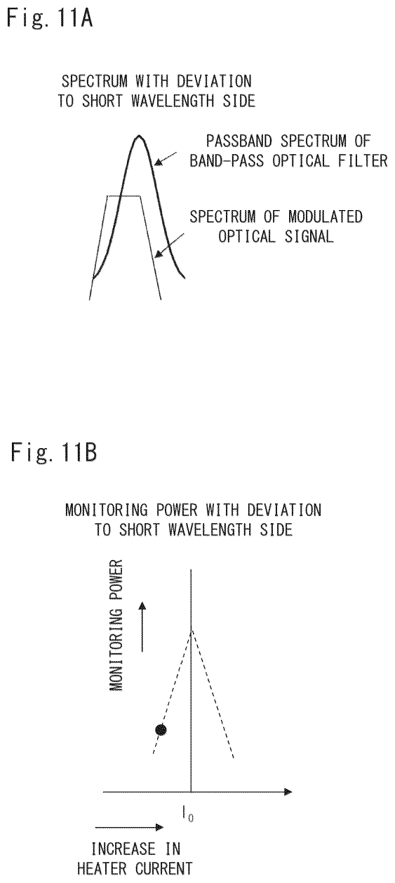

FIGS. 11A and 11B illustrate examples of a spectrum and monitoring power in a case where a wavelength of the light SO1 output from the single wavelength light source 110 is deviated from the set wavelength (λ0) to a short wavelength side. In this case, as illustrated in FIG. 11A, spectra of the modulated optical signal SO2 generated by the semiconductor modulator 120 and the monitoring optical signal SO4 branched from the demultiplexer 130 are deviated from a passband spectrum of the band-pass optical filter 140 to the short wavelength side. Thus, a portion on the short wavelength side of the monitoring optical signal SO4 not being included in the passband is cut by the band-pass optical filter 140. Then, as illustrated in FIG. 11B, in a case where a wavelength of the light SO1 is deviated to the short wavelength side with respect to the set wavelength (λ0), monitoring power (monitoring current) of the monitoring optical signal SO4 passing through the band-pass optical filter 140 is smaller than the maximum value. For example, since the monitoring power is smaller than the predetermined threshold value, the wavelength control unit 170 determines wavelength control necessary (S103), and controls a wavelength of the single wavelength light source 110 (S104). In this example, a wavelength of the single wavelength light source 110 is adjusted to a long wavelength side by increasing the heater current according to the monitoring power.

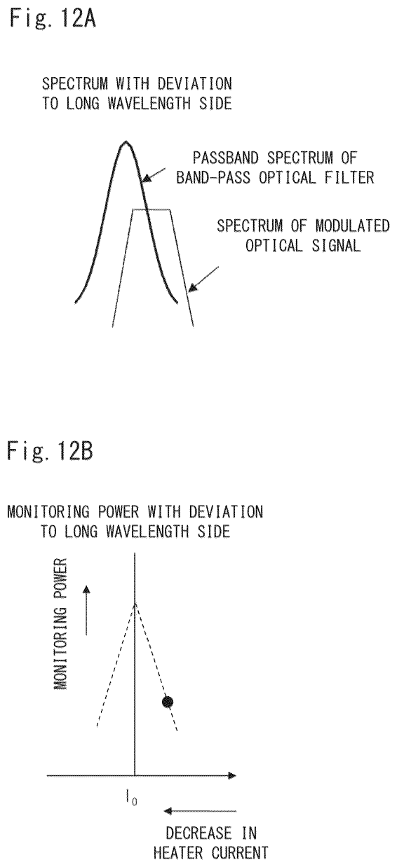

FIGS. 12A and 12B illustrate examples of a spectrum and monitoring power in a case where a wavelength of the light SO1 output from the single wavelength light source 110 is deviated from the set wavelength (λ0) to the long wavelength side. In this case, as illustrated in FIG. 12A, spectra of the modulated optical signal SO2 generated by the semiconductor modulator 120 and the monitoring optical signal SO4 branched from the demultiplexer 130 are deviated from a passband spectrum of the band-pass optical filter 140 to the long wavelength side. Thus, a portion on the long wavelength side of the monitoring optical signal SO4 not being included in the passband is cut by the band-pass optical filter 140. Then, as illustrated in FIG. 12B, in a case where a wavelength of the light SO1 is deviated to the long wavelength side with respect to the set wavelength (λ0), monitoring power (monitoring current) of the monitoring optical signal SO4 passing through the band-pass optical filter 140 is smaller than the maximum value. For example, since the monitoring power is smaller than the predetermined threshold value, the wavelength control unit 170 determines wavelength control necessary (S103), and controls a wavelength of the single wavelength light source 110 (S104). In this example, a wavelength of the single wavelength light source 110 is adjusted to the short wavelength side by decreasing the heater current according to the monitoring power.

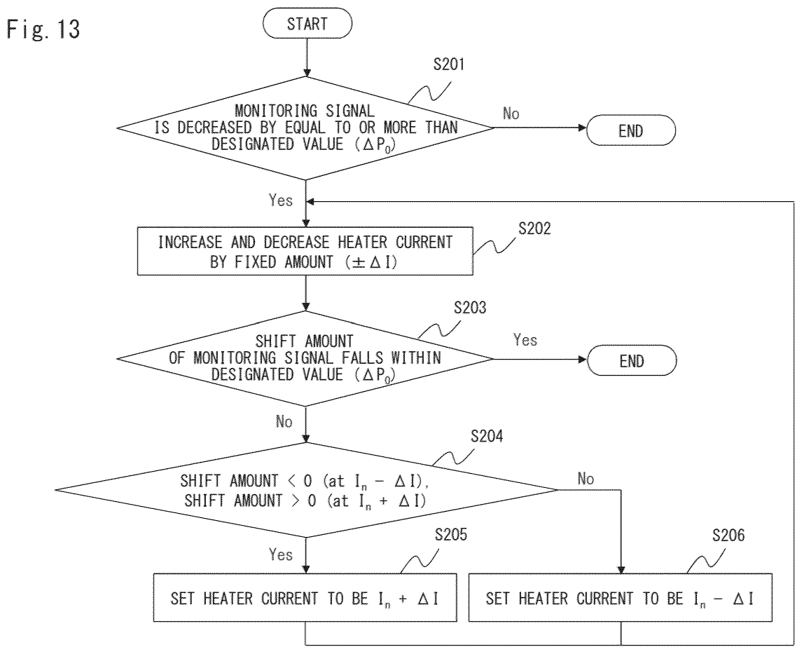

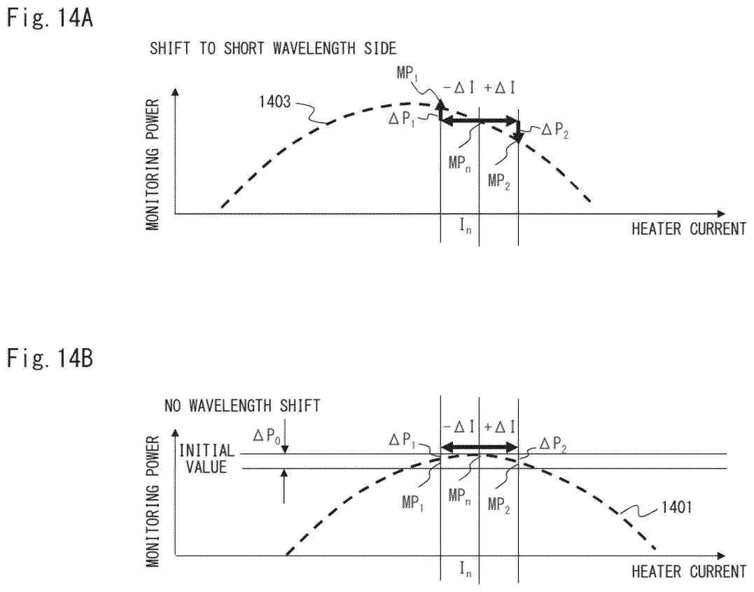

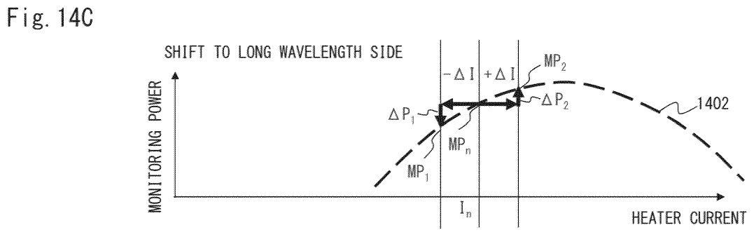

FIG. 13 illustrates a detailed operation example of the wavelength control processing of the single wavelength light source 110 according to some example embodiments. For example, S201 to S206 in FIG. 13 correspond to S103 to S104 in FIG. 9. FIGS. 14A-14C illustrate examples of monitoring power for describing the operation example in FIG. 13.

In the example in FIG. 13, the wavelength control unit 170 determines whether monitoring power of the monitoring signal MO output from the monitoring PD 150 is decreased by equal to or more than a designated value (ΔP₀) (S201). For example, the wavelength control unit 170 compares an initial value of the monitoring power (monitoring current) of the monitoring signal MO from the monitoring PD 150 when the initial value of the heater current HT is set in S101 in FIG. 9 with current monitoring power of the monitoring signal MO from the monitoring PD 150. The initial value of the monitoring power is monitoring power of the monitoring signal MO monitored by the monitoring PD 150 in a state where a wavelength of the light SO1 is not deviated. The wavelength control unit 170 determines whether the current monitoring power is decreased from the initial value of the monitoring power by equal to or more than the designated value.

In a case where the monitoring power of the monitoring signal MO is not decreased by equal to or more than the designated value (ΔP₀), the wavelength control unit 170 determines wavelength control unnecessary, and ends the wavelength control processing. Further, in a case where the monitoring power of the monitoring signal MO is decreased by equal to or more than the designated value (ΔP₀), the wavelength control unit 170 determines wavelength control necessary, and increases and decreases the heater current HT by a fixed amount (±ΔI) (S202). For example, the wavelength control unit 170 decreases the heater current HT from a current set value (Iₙ) by (−ΔI), and acquires the monitoring signal MO from the monitoring PD 150. Further, the wavelength control unit 170 increases the heater current HT from the current set value (Iₙ) by (±ΔI), and acquires the monitoring signal MO from the monitoring PD 150.

Next, the wavelength control unit 170 determines whether a shift amount of the monitoring power of the monitoring signal MO falls within a designated value (ΔP₀) (S203). Note that the designated value being a determination reference in S201 and the designated value being a determination reference in S203 may be the same value or may be different values. For example, the wavelength control unit 170 compares monitoring power (MPₙ) of the monitoring signal MO in a case where the heater current HT is the current set value (Iₙ) with monitoring power (MP₁) of the monitoring signal MO in a case where the heater current HT is decreased from the set value (Iₙ) by (−ΔI), and determines whether a difference (ΔP₁) between the monitoring power (MPₙ) and the monitoring power (MP₁) is equal to or less than the designated value (ΔP₀). Further, the wavelength control unit 170 compares the monitoring power (MPₙ) of the monitoring signal MO in a case where the heater current HT is the current set value (Iₙ) with monitoring power (MP₂) of the monitoring signal MO in a case where the heater current HT is increased from the set value (Iₙ) by (±ΔI), and determines whether a difference (ΔP₂) between the monitoring power (MPₙ) and the monitoring power (MP₂) is equal to or less than the designated value (ΔP₀).

In a case where the shift amount of the monitoring power of the monitoring signal MO falls within the designated value (ΔP₀), the wavelength control unit 170 determines wavelength control unnecessary, and ends the wavelength control processing. FIG. 14B illustrates an example in which heater current dependence (1401) of the monitoring power of the monitoring signal MO is not shifted, i.e., a wavelength of the monitoring signal MO is not shifted. For example, as indicated by 1401 in FIG. 14B, in a case where the difference (ΔP₁) between the monitoring power (MPₙ) in a case where the heater current HT is the set value (Iₙ) and the monitoring power (MP₁) in a case where the heater current HT is decreased by (−ΔI) is equal to or less than the designated value (ΔP₀), and the difference (ΔP₂) between the monitoring power (MPₙ) in a case where the heater current HT is the set value (Iₙ) and the monitoring power (MP₂) in a case where the heater current HT is increased by (±ΔI) is equal to or less than the designated value (ΔP₀), the heater current dependence of the monitoring power is not shifted, and thus a wavelength of the light SO1 is not deviated, and the wavelength control unit 170 determines wavelength control unnecessary.

Further, in a case where the shift amount of the monitoring power of the monitoring signal MO is greater than the designated value (ΔP₀), the wavelength control unit 170 determines wavelength control necessary, and proceeds the processing to next S204. For example, in a case where the difference (ΔP₁) between the monitoring power (MPₙ) in a case where the heater current HT is the set value (Iₙ) and the monitoring power (MP₁) in a case where the heater current HT is decreased by (−ΔI) is greater than the designated value (ΔP₀), or the difference (ΔP₂) between the monitoring power (MPₙ) in a case where the heater current HT is the set value (Iₙ) and the monitoring power (MP₂) in a case where the heater current HT is increased by (±ΔI) is greater than the designated value (ΔP₀), the wavelength control unit 170 determines wavelength control necessary.

In this case, the wavelength control unit 170 determines whether the shift amount of the monitoring power of the monitoring signal MO in a case where the heater current HT is (Iₙ−ΔI) is (ΔP₁)<0 and the shift amount of the monitoring power of the monitoring signal MO in a case where the heater current HT is (Iₙ+Δ_{I}) is (ΔP₂)>0 (S204). In other words, the wavelength control unit 170 determines whether an inclination of shift in the monitoring power in a case where the heater current is increased and decreased is positive.

For example, the wavelength control unit 170 determines whether the difference (ΔP₁) between the monitoring power (MPₙ) in a case where the heater current HT is the set value (Iₙ) and the monitoring power (MP₁) in a case where the heater current HT is decreased by (−Δ_{I}) is a negative value, and the difference (ΔP₂) between the monitoring power (MPₙ) in a case where the heater current HT is the set value (Iₙ) and the monitoring power (MP₂) in a case where the heater current HT is increased by (±Δ_{I}) is a positive value. In this way, whether a wavelength of the light SO1 is shifted to the long wavelength side (inclination is positive) or shifted to the short wavelength side (inclination is negative) with respect to the set wavelength (λ0) is determined.

In a case where the shift amount of the monitoring power of the monitoring signal MO in a case where the heater current HT is (Iₙ−ΔI) is (ΔP₁)<0 and the shift amount of the monitoring power of the monitoring signal MO in a case where the heater current HT is (Iₙ+Δ_{I}) is (ΔP₂)>0, the wavelength control unit 170 sets the heater current HT to be (Iₙ+Δ_{I}) (S205). FIG. 14C illustrates an example in which heater current dependence (1402) of the monitoring power of the monitoring signal MO is shifted to a high current side, i.e., a wavelength of the monitoring signal MO is shifted to the long wavelength side. For example, as indicated by 1402 in FIG. 14C, in a case where the difference (ΔP₁) between the monitoring power (MPₙ) in a case where the heater current HT is the set value (Iₙ) and the monitoring power (MP₁) in a case where the heater current HT is decreased by (−Δ_{I}) is a negative value, and the difference (ΔP₂) between the monitoring power (MPₙ) in a case where the heater current HT is the set value (Iₙ) and the monitoring power (MP₂) in a case where the heater current HT is increased by (±Δ_{I}) is a positive value, an inclination of shift in the monitoring power is positive, and the heater current dependence of the monitoring power is shifted to the high current side, and thus the wavelength control unit 170 determines that a wavelength of the light SOL is shifted to the short wavelength side with respect to the set wavelength (λ0). In this case, the wavelength control unit 170 adjusts the wavelength of the light SO1 to the long wavelength side by increasing the set value of the heater current HT by (±Δ_{I}). An amount in which the heater current HT is increased may be changed according to an inclination of the monitoring power.

Conversely, in a case where the shift amount of the monitoring power of the monitoring signal MO in a case where the heater current HT is (Iₙ−ΔI) is (ΔP₁)>0 and the shift amount of the monitoring power of the monitoring signal MO in a case where the heater current HT is (Iₙ+Δ_{I}) is (ΔP₂)<0, the wavelength control unit 170 sets the heater current HT to be (Iₙ−ΔI) (S206). FIG. 14A illustrates an example in which heater current dependence (1403) of the monitoring power of the monitoring signal MO is shifted to a low current side, i.e., a wavelength of the monitoring signal MO is shifted to the short wavelength side. For example, as indicated by 1403 in FIG. 14A, in a case where the difference (ΔP₁) between the monitoring power (MPₙ) in a case where the heater current HT is the set value (Iₙ) and the monitoring power (MP₁) in a case where the heater current HT is decreased by (−Δ_{I}) is a positive value, and the difference (ΔP₂) between the monitoring power (MPₙ) in a case where the heater current HT is the set value (Iₙ) and the monitoring power (MP₂) in a case where the heater current HT is increased by (±Δ_{I}) is a negative value, an inclination of shift in the monitoring power is negative, and the heater current dependence of the monitoring power is shifted to the low current side, and thus the wavelength control unit 170 determines that a wavelength of the light SO1 is shifted to the long wavelength side with respect to the set wavelength (λ0). In this case, the wavelength control unit 170 adjusts the wavelength of the light SO1 to the short wavelength side by decreasing the set value of the heater current HT by (ΔI). An amount in which the heater current HT is decreased may be changed according to an inclination of the monitoring power.

Returning to FIG. 9, in a case where wavelength control is determined unnecessary in S103 or in a case where wavelength control in S104 (including wavelength control in FIG. 13) ends, the optical transmitter 1 performs bias control processing of the semiconductor modulator 120 (S105 to S107).

In the bias control processing, the monitoring PD 150 monitors light through the band-pass optical filter 140 (S105). Similarly to S102, the semiconductor modulator 120 modulates the light SO1 subjected to wavelength control, and the monitoring PD 150 detects an optical signal through the band-pass optical filter 140, and converts the detected optical signal into a monitoring current (monitoring signal MO).

Next, the bias control unit 160 determines whether bias control (adjustment) of the semiconductor modulator 120 is necessary, based on a monitoring result of the monitoring PD 150 (S106). For example, the bias control unit 160 determines whether the monitoring current (monitoring signal MO) output from the monitoring PD 150 falls within a predetermined range, and determines bias control necessary in a case where the monitoring current exceeds the predetermined range.

Next, in a case where bias control is determined necessary, the bias control unit 160 controls (adjusts) the bias voltage BS of the semiconductor modulator 120 (S107). The bias control unit 160 controls each of the bias voltage BS1 applied to the MZ modulator 122-1, the bias voltage BS2 applied to the MZ modulator 122-2, and the bias voltage BS3 applied to the phase shifter 123, based on the detected monitoring current. For example, the bias control unit 160 repeats adjustment to the bias voltages BS1 to BS3 until the monitoring current falls within the predetermined range.

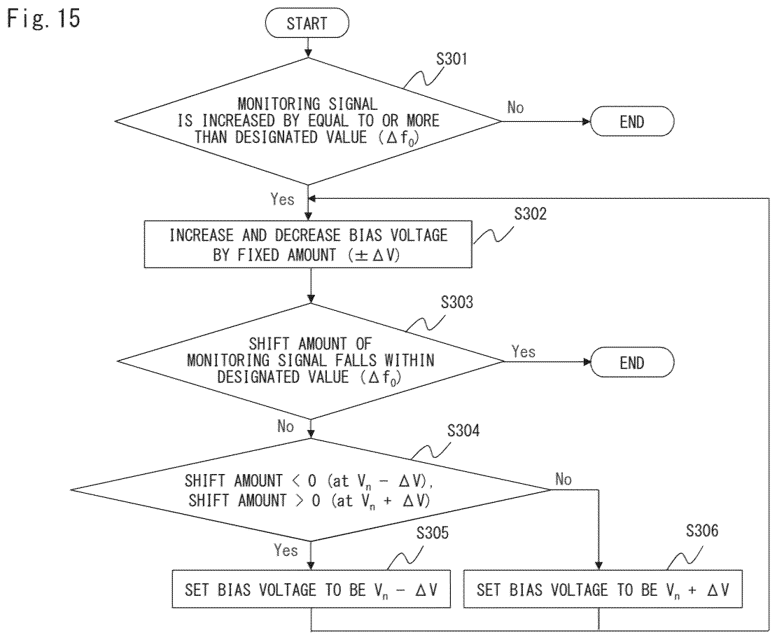

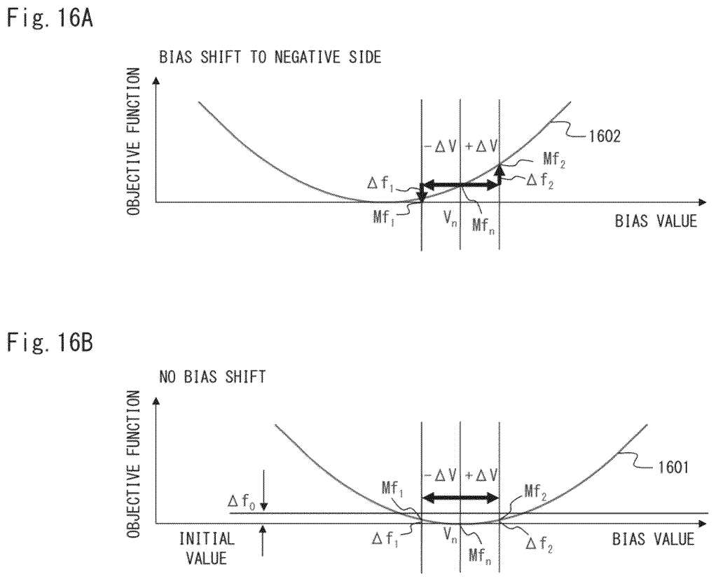

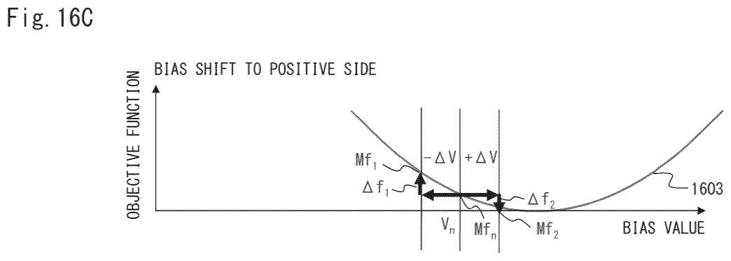

FIG. 15 illustrates a detailed operation example of the bias control processing of the semiconductor modulator 120 according to some example embodiments. For example, S301 to S306 in FIG. 15 correspond to S106 to S107 in FIG. 9. FIGS. 16A-16C illustrate examples of objective function values for describing the operation example in FIG. 15. In this example, an objective function value acquired by converting, by a predetermined objective function, monitoring power (monitoring current) of the monitoring signal MO output from the monitoring PD 150 is used. The objective function is a function used for bias voltage control of an MZ modulator. In a case of the MZ modulator, due to a deviation from an optimum bias point, an unconverted component passes as a DC component through the optical modulator (semiconductor modulator 120). Thus, the monitoring signal MO mainly includes the DC component, and the DC component is decreased as the optimum bias point is closer, and thus a function for decreasing the component is set as an objective function. For example, as in FIGS. 16A-16C, in a case where a bias voltage supplied to the modulator is optimum, i.e., in a case where a bias point of the modulator is not deviated, an objective function value obtained from power of light modulated by the modulator is a minimum value.

In the example in FIG. 15, the bias control unit 160 determines whether an objective function value based on the monitoring signal MO output from the monitoring PD 150 is increased by equal to or more than a designated value (Δf₀) (S301). For example, the bias control unit 160 compares an initial value of the objective function value acquired by converting, by an objective function, the monitoring power (monitoring current) of the monitoring signal MO from the monitoring PD 150 when the initial value of the bias voltage BS is set in S101 in FIG. 9 with a current objective function value acquired by converting, by the objective function, the monitoring power of the monitoring signal MO from the monitoring PD 150. The initial value of the objective function value is an objective function value acquired by converting the monitoring power of the monitoring signal MO monitored by the monitoring PD 150 in a state where a bias point of the semiconductor modulator 120 is not deviated. The bias control unit 160 determines whether the current objective function value with respect to the initial value of the objective function value is equal to or more than the designated value.

In a case where the objective function value based on the monitoring signal MO is not increased by equal to or more than the designated value (Δf₀), the bias control unit 160 determines bias control unnecessary, and ends the bias control processing. Further, in a case where the objective function value based on the monitoring signal MO is increased by equal to or more than the designated value (Δf₀), the bias control unit 160 determines bias control necessary, and increases and decreases the bias voltage BS by a fixed amount (±ΔV) (S302). For example, the bias control unit 160 decreases the bias voltage BS from a current set value (Vₙ) by (−ΔV), and acquires the monitoring signal MO from the monitoring PD 150. Further, the bias control unit 160 increases the bias voltage BS from the current set value (Vₙ) by (+ΔV), and acquires the monitoring signal MO from the monitoring PD 150.

Next, the bias control unit 160 determines whether a shift amount of the objective function value based on the monitoring signal MO falls within the designated value (Δf₀) (S303). Note that the designated value being a determination reference in S301 and the designated value being a determination reference in S303 may be the same value or may be different values. For example, the bias control unit 160 compares an objective function value (Mfₙ) based on the monitoring signal MO in a case where the bias voltage BS is the current set value (Vₙ) with an objective function value (Mf₁) based on the monitoring signal MO in a case where the bias voltage BS is decreased from the set value (Vₙ) by (−ΔV), and determines whether a difference (Δf₁) between the objective function value (Mfₙ) and the objective function value (Mf₁) is equal to or less than the designated value (Δf₀). Further, the bias control unit 160 compares the objective function value (Mfₙ) based on the monitoring signal MO in a case where the bias voltage BS is the current set value (Vₙ) with an objective function value (Mf₂) based on the monitoring signal MO in a case where the bias voltage BS is increased from the set value (Vₙ) by (+ΔV), and determines whether a difference (Δf₂) between the objective function value (Mfₙ) and the objective function value (Mf₂) is equal to or less than the designated value (Δf₀).

In a case where the shift amount of the objective function value based on the monitoring signal MO falls within the designated value (Δf₀), the bias control unit 160 determines bias control unnecessary, and ends the bias control processing. FIG. 16B illustrates an example in which bias value dependence (1601) of an objective function is not shifted. For example, as indicated by 1601 in FIG. 16B, in a case where the difference (Δf₁) between the objective function value (Mfₙ) in a case where the bias voltage BS is the set value (Vₙ) and the objective function value (Mf₁) in a case where the bias voltage BS is decreased by (−ΔV) is equal to or less than the designated value (Δf₀), and the difference (Δf₂) between the objective function value (Mfₙ) in a case where the bias voltage BS is the set value (Vₙ) and the objective function value (Mf₂) in a case where the bias voltage BS is increased by (+ΔV) is equal to or less than the designated value (Δf₀), the bias value dependence of the objective function is not shifted, and thus the bias control unit 160 determines bias control unnecessary.

Further, in a case where the shift amount of the objective function value based on the monitoring signal MO is greater than the designated value (Δf₀), the bias control unit 160 determines bias control necessary, and proceeds the processing to next S304. For example, in a case where the difference (Δf₁) between the objective function value (Mfₙ) in a case where the bias voltage BS is the set value (Vₙ) and the objective function value (Mf₁) in a case where the bias voltage BS is decreased by (−ΔV) is greater than the designated value (Δf₀), or the difference (Δf₂) between the objective function value (Mfₙ) in a case where the bias voltage BS is the set value (Vₙ) and the objective function value (Mf₂) in a case where the bias voltage BS is increased by (+ΔV) is greater than the designated value (Δf₀), the bias control unit 160 determines bias control necessary.

In this case, the bias control unit 160 determines whether the shift amount of the objective function value based on the monitoring signal MO in a case where the bias voltage BS is (Vₙ−ΔV) is (Δf₁)<0 and the shift amount of the objective function value based on the monitoring signal MO in a case where the bias voltage BS is (Vₙ+ΔV) is (Δf₂)>0 (S304). In other words, the bias control unit 160 determines whether an inclination of shift in the objective function value in a case where the bias voltage is increased and decreased is positive.

For example, the bias control unit 160 determines whether the difference (Δf₁) between the objective function value (Mfₙ) in a case where the bias voltage BS is the set value (Vₙ) and the objective function value (Mf₁) in a case where the bias voltage BS is decreased by (−ΔV) is a negative value, and the difference (Δf₂) between the objective function value (Mfₙ) in a case where the bias voltage BS is the set value (Vₙ) and the objective function value (Mf₂) in a case where the bias voltage BS is increased by (+ΔV) is a positive value. In this way, whether a bias point of the semiconductor modulator 120 is shifted to a negative side (inclination is positive) or shifted to a positive side (inclination is negative) as compared to an initial setting time is determined.

In a case where the shift amount of the objective function value based on the monitoring signal MO in a case where the bias voltage BS is (Vₙ−ΔV) is (Δf₁)<0 and the shift amount of the objective function value based on the monitoring signal MO in a case where the bias voltage BS is (Vₙ+ΔV) is (Δf₂)>0, the bias control unit 160 sets the bias voltage BS to be (Vₙ−ΔV) (S305). FIG. 16A illustrates an example in which bias value dependence (1602) of an objective function is shifted to a low bias side. For example, as indicated by 1602 in FIG. 16A, in a case where the difference (Δf₁) between the objective function value (Mfₙ) in a case where the bias voltage BS is the set value (Vₙ) and the objective function value (Mf₁) in a case where the bias voltage BS is decreased by (−ΔV) is a negative value, and the difference (Δf₂) between the objective function value (Mfₙ) in a case where the bias voltage BS is the set value (Vₙ) and the objective function value (Mf₂) in a case where the bias voltage BS is increased by (+ΔV) is a positive value, the bias control unit 160 determines that an inclination of shift in the objective function value is positive and the bias value dependence of the objective function is shifted to the low bias side. In this case, the bias control unit 160 adjusts the objective function value to be decreased by decreasing the set value of the bias voltage BS by (−ΔV). An amount in which the bias voltage BS is decreased may be changed according to an inclination of the objective function value.

Conversely, in a case where the shift amount of the objective function value based on the monitoring signal MO in a case where the bias voltage BS is (Vₙ−ΔV) is (Δf₁)>0 and the shift amount of the objective function value based on the monitoring signal MO in a case where the bias voltage BS is (Vₙ+ΔV) is (Δf₂)<0, the bias control unit 160 sets the bias voltage BS to be (Vₙ+ΔV) (S306). FIG. 16C illustrates an example in which bias value dependence (1603) of an objective function is shifted to a high bias side. For example, as indicated by 1603 in FIG. 16C, in a case where the difference (Δf₁) between the objective function value (Mfₙ) in a case where the bias voltage BS is the set value (Vₙ) and the objective function value (Mf₁) in a case where the bias voltage BS is decreased by (−ΔV) is a positive value, and the difference (Δf₂) between the objective function value (Mfₙ) in a case where the bias voltage BS is the set value (Vₙ) and the objective function value (Mf₂) in a case where the bias voltage BS is increased by (+ΔV) is a negative value, the bias control unit 160 determines that an inclination of shift in the objective function value is negative and the bias value dependence of the objective function is shifted to the high bias side. In this case, the bias control unit 160 adjusts the objective function value to be decreased by increasing the set value of the bias voltage BS by (+ΔV). An amount in which the bias voltage BS is increased may be changed according to an inclination of the objective function value.

Returning to FIG. 9, subsequently, the optical transmitter 1 repeats the wavelength control processing (S102 to S104) and the bias control processing (S105 to S107) in order. The wavelength control processing and the bias control processing may be always repeated or may be regularly repeated. Once a wavelength of the single wavelength light source 110 is adjusted by the wavelength control processing, the wavelength control processing and the bias control processing may be then performed independently. In other words, the wavelength control processing and the bias control processing may be performed in parallel or may be each performed in a different cycle. Since a period from an adjustment to a wavelength of a light source to a deviation of the wavelength is longer than a period from an adjustment to a bias voltage to a deviation of a bias point of a semiconductor modulator, the bias control processing may be performed in a first cycle, and the wavelength control processing may be performed in a second cycle longer than the first cycle.

As described above, in the present example embodiment, in an optical transmitter in which a single wavelength light source such as a DFB laser and a wavelength tunable light source and a semiconductor modulator are integrated on the same substrate, an optical band-pass filter with a set wavelength as a center pass wavelength is disposed on a prior stage of a monitoring PD. Further, light from the semiconductor modulator is branched by a coupler, and the branched light is input to the band-pass filter. In wavelength control and bias control, wavelength control is performed by performing identification in a wavelength control unit by using an electric signal output from the monitoring PD and controlling a heater current of a light source, and then a bias voltage of an optical modulator is controlled by performing identification processing in a bias control unit by using an electric signal output from the monitoring PD.

In this way, the semiconductor modulator, the light source, and the like are integrated, and wavelength control and bias control can also be suitably performed. Specifically, a size reduction and power savings can be achieved by integrating the semiconductor modulator, the light source, and the like on the same semiconductor substrate. By monitoring light through the band-pass filter, and performing bias control and wavelength control, based on a monitoring result, bias control and wavelength control can be performed by one monitoring PD. By controlling heat of a heater formed in the light source by a heater current according to a monitoring result, a wavelength of the light source can be controlled without using a large temperature adjustment function such as a TEC, and thus wavelength control of the light source and bias control of the semiconductor modulator can be brought close and performed in a smaller area. Further, by branching light from the semiconductor modulator and monitoring the branched light, wavelength control and bias control can be performed while an influence on light output to the outside such as an optical transmission path is suppressed.

### Second Example Embodiment

Next, a second example embodiment will be described. In the present example embodiment, an example in which a pass bandwidth of a band-pass optical filter is set narrow and presence or absence of the band-pass optical filter can be switched will be described. Note that the present example embodiment may be implemented in combination with the first example embodiment, and each configuration indicated in the first example embodiment may be appropriately used.

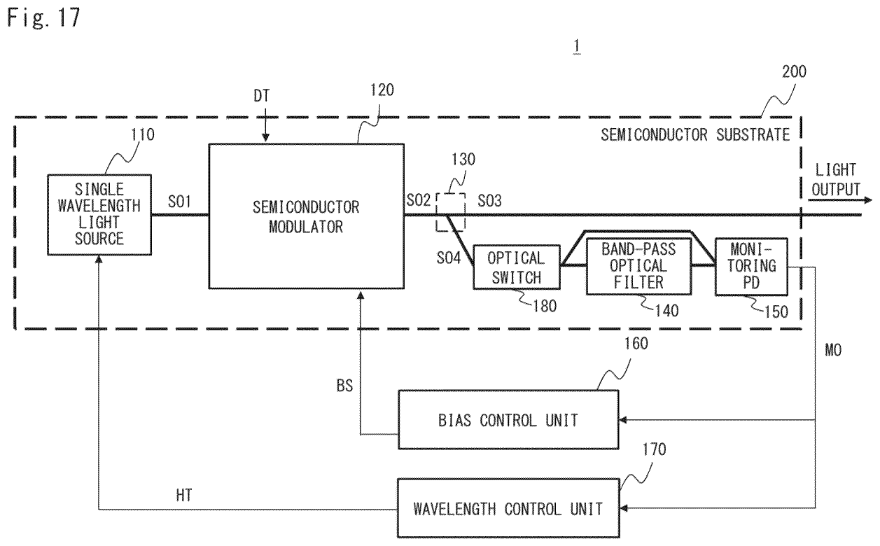

FIG. 17 illustrates a configuration example of an optical transmitter 1 according to some example embodiments. In the example in FIG. 17, the optical transmitter 1 includes an optical switch 180 in addition to the configuration in FIG. 5. Another configuration is similar to that in the example in FIG. 5.

The optical switch 180 is a switching unit that is disposed between a demultiplexer 130 and a band-pass optical filter 140 and switches the band-pass optical filter 140 in such a way that the band-pass optical filter 140 can be bypassed. It can be said that the optical switch 180 switches presence or absence of the band-pass optical filter 140 (presence or absence of use). For example, the optical switch 180 is formed on a semiconductor substrate 200 similarly to the demultiplexer 130, the band-pass optical filter 140, and the like. The optical switch 180 switches an output destination of a monitoring optical signal SO4 from the demultiplexer 130, and outputs the monitoring optical signal SO4 to any of the band-pass optical filter 140 and a monitoring PD 150. In this way, whether to bypass the band-pass optical filter 140, i.e., whether to cause the band-pass optical filter 140 to filter the monitoring optical signal SO4 is switched.

For example, in a case where a wavelength control unit 170 performs wavelength control processing, an output of the demultiplexer 130 is connected to an input of the band-pass optical filter 140, and an output destination of the monitoring optical signal SO4 is switched to the band-pass optical filter 140. In this way, the monitoring optical signal SO4 is filtered by the band-pass optical filter 140, and the monitoring optical signal SO4 passing through the band-pass optical filter 140 is detected by the monitoring PD 150. Further, in a case where a bias control unit 160 performs bias control processing, an output of the demultiplexer 130 is connected to an input of the monitoring PD 150, and an output destination of the monitoring optical signal SO4 is switched to the monitoring PD 150. In this way, the band-pass optical filter 140 is bypassed, and the monitoring optical signal SO4 branched by the demultiplexer 130 is directly detected by the monitoring PD 150.

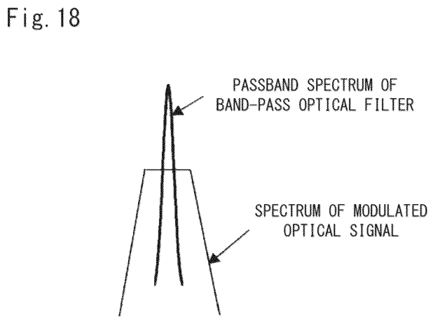

In the present example embodiment, a bandwidth of a passband of the band-pass optical filter 140 is narrower than that in the first example embodiment. FIG. 18 illustrates an example of a passband spectrum of the band-pass optical filter 140. As illustrated in FIG. 18, for example, a bandwidth of the passband spectrum is narrower than a bandwidth of a modulated optical signal SO2 output from the semiconductor modulator 120. A bandwidth of the passband of the band-pass optical filter 140 may be associated with a bandwidth of the light SO1 output from a single wavelength light source 110. A bandwidth of the passband of the band-pass optical filter 140 is wider than a bandwidth of the light SO1 or substantially the same width as a bandwidth of the light SO1, and may be a bandwidth that can pass at least the light SO1.

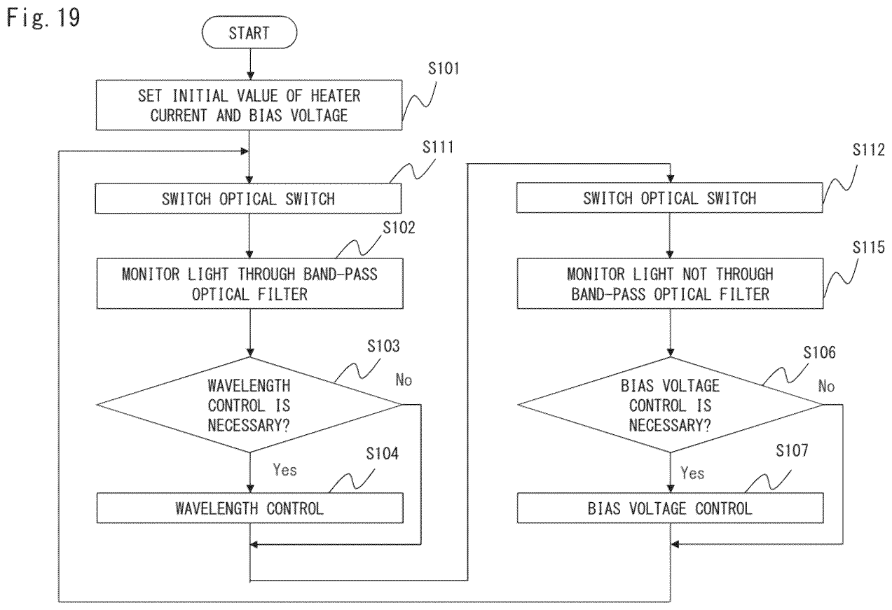

FIG. 19 illustrates an operation example of the optical transmitter 1 according to some example embodiments. In the example in FIGS. 19, S111 and S112 are added and S105 is changed to S115 with respect to the operation example in FIG. 9.

In the example in FIG. 19, similarly to FIG. 9, the optical transmitter 1 sets an initial value of a heater current HT of the single wavelength light source 110 and a bias voltage BS of the semiconductor modulator 120 (S101), and then switches a connection of the optical switch 180 in such a way as to use the band-pass optical filter 140 in order to perform the wavelength control processing (S111). The optical switch 180 sets an output destination of the monitoring optical signal SO4 from the demultiplexer 130 to be the band-pass optical filter 140.

Next, similarly to FIG. 9, the optical transmitter 1 performs the wavelength control processing (S102 to S104). The band-pass optical filter 140 passes the monitoring optical signal SO4 from the optical switch 180 in a passband narrow as in FIG. 18. The monitoring PD 150 monitors an optical signal passing through the band-pass optical filter 140, and the wavelength control unit 170 controls a wavelength of the single wavelength light source 110 according to the monitoring result.

Next, the optical transmitter 1 switches a connection of the optical switch 180 in such a way as to bypass the band-pass optical filter 140 in order to perform the bias control processing (S112). The optical switch 180 sets an output destination of the monitoring optical signal SO4 from the demultiplexer 130 to be the monitoring PD 150.

Next, similarly to FIG. 9, the optical transmitter 1 performs the bias control processing (S115, S106 to S107). The monitoring PD 150 monitors the monitoring optical signal SO4 from the optical switch 180 without interposing the band-pass optical filter 140 (S115). The bias control unit 160 controls the bias voltage BS of the semiconductor modulator 120, based on the monitoring result (S106 to S107).

As described above, in the present example embodiment, a passband of a band-pass filter is set narrow and presence or absence of the band-pass filter can be selected. By monitoring light passing through the band-pass filter in the narrow passband in a case where wavelength control is performed, accuracy of wavelength control can be improved. Further, by bypassing the band-pass filter in a case where bias control is performed, an influence of the band-pass filter in the narrow passband can be suppressed, and bias control can be accurately performed.

### Third Example Embodiment

Next, a third example embodiment will be described. In the present example embodiment, an example in which an optical transmitter includes a DP-IQ modulator as a semiconductor modulator will be described. Note that the present example embodiment may be implemented in combination with the first or second example embodiment, and each configuration indicated in the first or second example embodiment may be appropriately used.

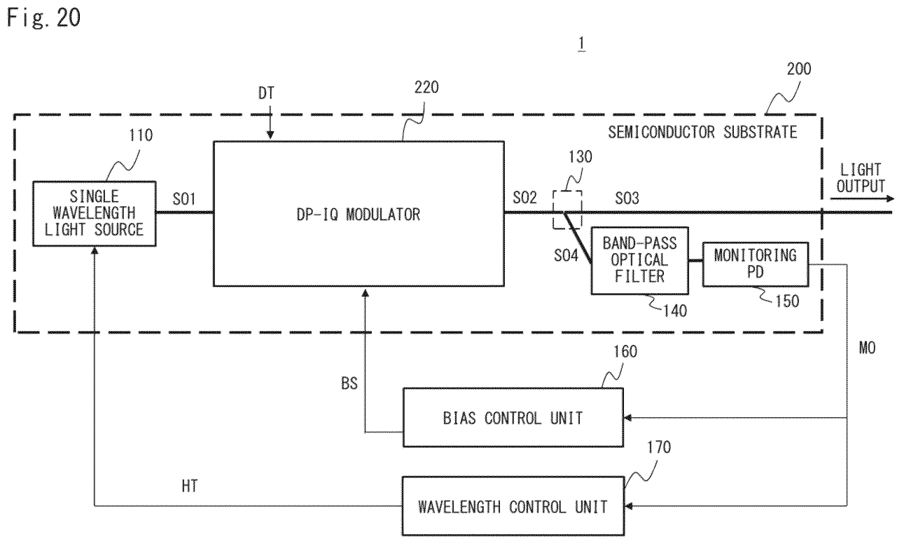

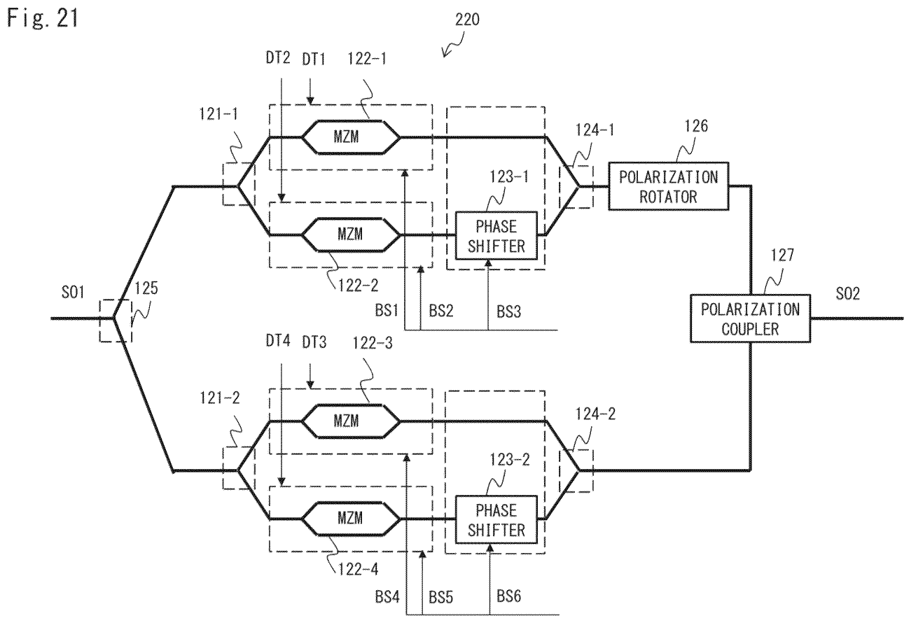

FIG. 20 illustrates a configuration example of an optical transmitter 1 according to some example embodiments. FIG. 21 illustrates a specific configuration example of a DP-IQ modulator 220 in FIG. 20. In the example in FIG. 20, the optical transmitter 1 includes the DP-IQ modulator 220 as the semiconductor modulator 120 in FIG. 5. Another configuration is similar to that in the example in FIG. 5.

The DP-IQ modulator 220 is an IQ modulator of a dual polarization (DP) type, and is a semiconductor modulator formed on a semiconductor substrate 200. As illustrated in FIG. 21, the DP-IQ modulator 220 includes two IQ modulators constituting the semiconductor modulator 120 in FIG. 8. One of the two IQ modulators is an IQ modulator for X polarization, and the other is an IQ modulator for Y polarization.

Specifically, the DP-IQ modulator 220 includes demultiplexers 121-1 to 121-2, MZ modulators 122-1 to 122-4, phase shifters 123-1 to 123-2, multiplexers 124-1 to 124-2, a demultiplexer 125, a polarization rotator 126, and a polarization coupler 127. The demultiplexer 125 branches (demultiplexes) the light SO1 from a single wavelength light source 110 into light for X polarization and light for Y polarization.

The demultiplexer 121-1, the MZ modulators 122-1 to 122-2, the phase shifter 123-1, and the multiplexer 124-1 constitute, for example, an IQ modulator for X polarization. The demultiplexer 121-2, the MZ modulators 122-3 to 122-4, the phase shifter 123-2, and the multiplexer 124-2 constitute, for example, an IQ modulator for Y polarization. Each configuration of the IQ modulator for X polarization and the IQ modulator for Y polarization is similar to the semiconductor modulator 120 in FIG. 8.

A bias voltage BS1 is applied to the MZ modulator 122-1, and the MZ modulator 122-1 modulates, according to a data signal DT1, light for Ich of X polarization being branched by the demultiplexer 121-1. A bias voltage BS2 is applied to the MZ modulator 122-2, and the MZ modulator 122-2 modulates, according to a data signal DT2, light for Qch of X polarization being branched by the demultiplexer 121-1. A bias voltage BS3 is applied to the phase shifter 123-1, and the phase shifter 123-1 shifts a phase of a modulated optical signal for Qch of X polarization being modulated by the MZ modulator 122-2.

A bias voltage BS4 is applied to the MZ modulator 122-3, and the MZ modulator 122-3 modulates, according to a data signal DT3, light for Ich of Y polarization being branched by the demultiplexer 121-2. A bias voltage BS5 is applied to the MZ modulator 122-4, and the MZ modulator 122-4 modulates, according to a data signal DT4, light for Qch of Y polarization being branched by the demultiplexer 121-2. A bias voltage BS6 is applied to the phase shifter 123-2, and the phase shifter 123-2 shifts a phase of a modulated optical signal for Qch of Y polarization being modulated by the MZ modulator 122-4.

The polarization rotator 126 rotates a polarization direction of a modulated optical signal output from the IQ modulator for X polarization or a modulated optical signal output from the IQ modulator for Y polarization in such a way that the polarization direction of the modulated optical signal output from the IQ modulator for X polarization and the polarization direction of the modulated optical signal output from the IQ modulator for Y polarization are orthogonal to each other. In this example, the polarization rotator 126 rotates, through 90 degrees, the modulated optical signal output from the IQ modulator (multiplexer 124-1) for X polarization.

The polarization coupler 127 performs polarization coupling on the modulated optical signal of X polarization being output from the IQ modulator (multiplexer 124-1) for X polarization and having the polarization direction rotated, and the modulated optical signal of Y polarization being output from the IQ modulator (multiplexer 124-2) for Y polarization, and outputs the optical signal subjected to polarization coupling as a modulated optical signal SO2.

In the example in FIG. 20, the demultiplexer 130 branches the modulated optical signal SO2 being generated by the DP-IQ modulator 220 and including X polarization and Y polarization into an output optical signal SO3 for output and a monitoring optical signal SO4 for monitoring. A bias control unit 160 controls the bias voltage BS of the DP-IQ modulator 220, based on a monitoring signal MO passing through a band-pass optical filter 140 and being monitored by a monitoring PD 150. Specifically, the bias control unit 160 controls each of the bias voltage BS1 of the MZ modulator 122-1, the bias voltage BS2 of the MZ modulator 122-2, the bias voltage BS3 of the phase shifter 123-1, the bias voltage BS4 of the MZ modulator 122-3, the bias voltage BS5 of the MZ modulator 122-4, and the bias voltage BS6 of the phase shifter 123-2, based on the monitoring signal MO. Similarly to the first example embodiment, a wavelength control unit 170 controls a wavelength of the single wavelength light source 110, based on the monitoring signal MO.

As described above, the optical transmitter may include the DP-IQ modulator as the semiconductor modulator. Also, in this case, the DP-IQ modulator and the like can be integrated, and bias control and wavelength control can be suitably performed, similarly to the first example embodiment.

### Fourth Example Embodiment

Next, a fourth example embodiment will be described. In the present example embodiment, an example in which an optical transmitter includes a plurality of DP-IQ modulators will be described. Note that the present example embodiment may be implemented in combination with any of the first to third example embodiments, and each configuration indicated in any of the first to third example embodiments may be appropriately used.

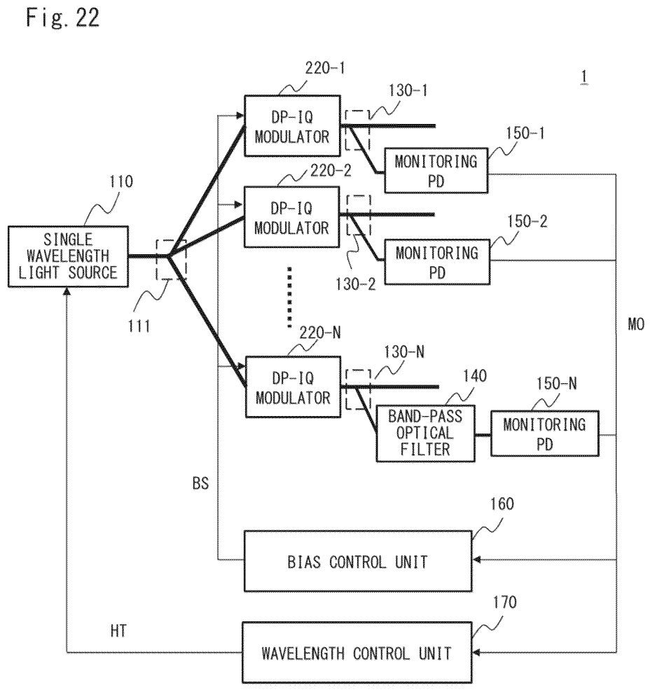

FIG. 22 illustrates a configuration example of an optical transmitter 1 according to some example embodiments. In the example in FIG. 22, the optical transmitter 1 includes a plurality of DP-IQ modulators 220-1 to 220-N (modulator array). The DP-IQ modulators 220-1 to 220-N are the DP-IQ modulator illustrated in FIG. 20.

In the example in FIG. 22, a single wavelength light source 110, a demultiplexer 111, the DP-IQ modulators 220-1 to 220-N, demultiplexers 130-1 to 130-N, a band-pass optical filter 140, and monitoring PDs 150-1 to 150-N are provided on a semiconductor substrate 200.

The demultiplexer 111 branches (demultiplexes) the light SO1 from the single wavelength light source 110 into the DP-IQ modulators 220-1 to 220-N. The DP-IQ modulators 220-1 to 220-N each modulate light branched from the demultiplexer 111. The demultiplexers 130-1 to 130-N each branch the modulated optical signal generated by the DP-IQ modulators 220-1 to 220-N into an output optical signal and a monitoring optical signal.

The band-pass optical filter 140 passes, by a passband, the monitoring optical signal branched by any of the demultiplexers 130-1 to 130-N. In this example, the band-pass optical filter 140 passes the monitoring optical signal generated by the DP-IQ modulator 220-N (for example, a first semiconductor modulator) and branched by the demultiplexer 130-N (for example, a first demultiplexer). The band-pass optical filter 140 may pass the monitoring optical signal branched by the other demultiplexer 130 instead of the demultiplexer 130-N.

The monitoring PD 150-N monitors an optical signal passing through the band-pass optical filter 140. The other monitoring PDs 150-1 to 150-N−1 each monitor the monitoring optical signal generated by the DP-IQ modulators 220-1 to 220-N−1 and branched by the demultiplexers 130-1 to 130-N−1.

A bias control unit 160 controls each bias voltage BS of the DP-IQ modulators 220-1 to 220-N, based on a monitoring signal MO monitored by the monitoring PDs 150-1 to 150-N. In other words, the bias control unit 160 controls each bias voltage BS of the DP-IQ modulators 220-1 to 220-N, based on an optical signal modulated by the DP-IQ modulators 220-1 to 220-N and branched by the demultiplexers 130-1 to 130-N. The bias control unit 160 controls the bias voltage BS of the DP-IQ modulator 220-1 according to a monitoring result of the monitoring PD 150-1, controls the bias voltage BS of the DP-IQ modulator 220-2 according to a monitoring result of the monitoring PD 150-2, . . . , and controls the bias voltage BS of the DP-IQ modulator 220-N according to a monitoring result of the monitoring PD 150-N. Similarly to the first example embodiment, a wavelength control unit 170 controls a wavelength of the single wavelength light source 110, based on the monitoring signal MO monitored by the monitoring PD 150-N. In other words, the wavelength control unit 170 controls a wavelength of the single wavelength light source 110, based on an optical signal modulated by any of the DP-IQ modulators 220-1 to 220-N and branched by the demultiplexer 130.

As described above, the optical transmitter may include the plurality of DP-IQ modulators as the semiconductor modulator. Also, in this case, the plurality of DP-IQ modulators and the like can be integrated, and bias control and wavelength control can be suitably performed, similarly to the first example embodiment.

### Fifth Example Embodiment

Next, a fifth example embodiment will be described. In the present example embodiment, an example in which an optical transmitter includes a plurality of DP-IQ modulators and a multiwavelength light source will be described. Note that the present example embodiment may be implemented in combination with any of the first to fourth example embodiments, and each configuration indicated in any of the first to fourth example embodiments may be appropriately used.

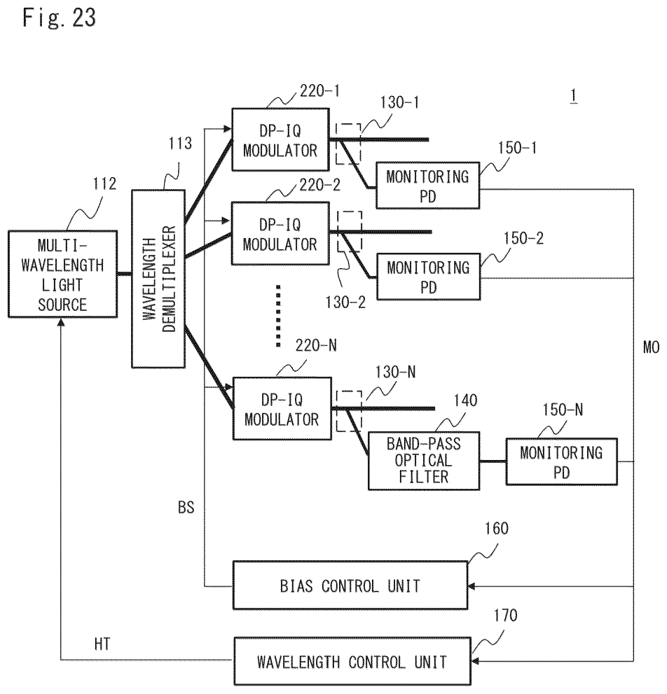

FIG. 23 illustrates a configuration example of an optical transmitter 1 according to some example embodiments. In the example in FIG. 23, the optical transmitter 1 includes a multiwavelength light source 112 instead of the single wavelength light source 110 and includes a wavelength demultiplexer 113 instead of the demultiplexer 111 with respect to the configuration in FIG. 22. Another configuration is similar to that in the example in FIG. 22.

The multiwavelength light source 112 is a light source that outputs the light SO1, which is a multiwavelength light (with a plurality of wavelengths), and outputs light with wavelengths of λ1 to λN. For example, the multiwavelength light source 112 outputs light with a plurality of wavelengths having a wavelength spacing locked at a regular spacing. The multiwavelength light source 112 is a comb light source such as a mode-locked laser, for example.

The wavelength demultiplexer 113 demultiplexes (branches), for each wavelength, the light SO1 with the plurality of wavelengths being output from the multiwavelength light source 112. The wavelength demultiplexer 113 is, for example, arrayed waveguide gratings (AWG). The wavelength demultiplexer 113 outputs, for each wavelength, optical signals with the wavelengths λ1 to λN from the multiwavelength light source 112 to DP-IQ modulators 220-1 to 220-N. Specifically, the wavelength demultiplexer 113 outputs the optical signal with the wavelength λ1 to the DP-IQ modulator 220-1, outputs the optical signal with the wavelength 22 to the DP-IQ modulator 220-2, . . . , and outputs the optical signal with the wavelength λN to the DP-IQ modulator 220-N.

Similarly to FIG. 22, the DP-IQ modulators 220-1 to 220-N each modulate light with each wavelength being branched from the wavelength demultiplexer 113. Demultiplexers 130-1 to 130-N, a band-pass optical filter 140, monitoring PDs 150-1 to 150-N, and a bias control unit 160 are also similar to those in FIG. 22. Note that, in a case where the band-pass optical filter 140 passes a monitoring optical signal being generated by the DP-IQ modulator 220-N and branched by the demultiplexer 130-N, a passband of the band-pass optical filter 140 is associated with a wavelength (AN) of an optical signal modulated by the DP-IQ modulator 220-N.

A wavelength control unit 170 controls all of a plurality of wavelengths of the multiwavelength light source 112, based on a monitoring signal MO monitored by the monitoring PD 150-N.

Similarly to the first example embodiment, the wavelength control unit 170 controls a plurality of wavelengths by supplying a heater current to a heater formed in the multiwavelength light source 112. For example, since a spacing between the plurality of wavelengths is locked in the multiwavelength light source 112, the plurality of wavelengths can be collectively controlled by controlling the heater current according to a monitoring result of an optical signal modulated by any of the modulators.

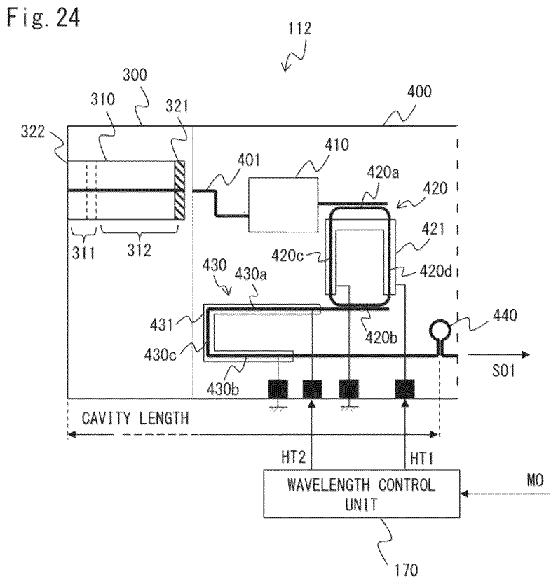

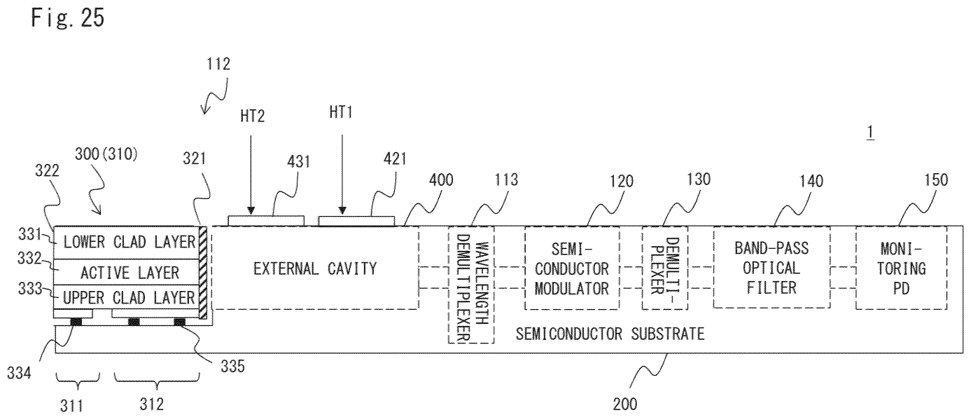

FIG. 24 is a schematic top view illustrating a configuration example of the multiwavelength light source 112 according to some example embodiments. FIG. 25 is a schematic side view illustrating one example of an arrangement of each unit in a semiconductor substrate 200 according to some example embodiments, and illustrates a side configuration example of the multiwavelength light source 112.

In the examples in FIGS. 24 and 25, the multiwavelength light source 112 is an external cavity semiconductor laser including an optical amplifier element 300 and an external cavity 400, and constitutes a mode-locked laser light source that generates light having a predetermined longitudinal mode spacing.

The optical amplifier element 300 is a semiconductor chip including a reflective semiconductor optical amplifier (RSOA) 310. The reflective semiconductor optical amplifier 310 is an optical amplifier that emits amplified light to the external cavity 400 and reflects light from the external cavity 400. An anti reflection (AR) coat 321 is formed on an end surface on an emission side (external cavity side) of the reflective semiconductor optical amplifier 310. The AR coat 321 suppresses unnecessary reflection of light reciprocating between the reflective semiconductor optical amplifier 310 and the external cavity 400. An end surface of the reflective semiconductor optical amplifier 310 on an opposite side to the AR coat 321 is a reflective end surface 322 that reflects light. For example, the reflective end surface 322 has a reflectance of about 30% in a cleavage based on a crystalline structure, but a high reflection (HR) coat may be formed.

As in FIG. 25, the optical amplifier element 300 including the reflective semiconductor optical amplifier 310 is formed of a lower clad layer 331, an active layer 332, and an upper clad layer 333 being multi-layered. In this example, similarly to the single wavelength light source in FIG. 7, the optical amplifier element 300 is mounted on the semiconductor substrate 200 by a flip chip method. Note that, similarly to the single wavelength light source in FIG. 6, the optical amplifier element 300 may be integrated on the semiconductor substrate 200 in a monolithic manner.

The reflective semiconductor optical amplifier 310 is a reflective semiconductor optical amplifier including a saturable absorption region, and includes a saturable absorption region 311 and a gain region 312. A saturable absorption region electrode (first electrode) 334 is formed on a front surface (lowest surface in FIG. 25) of the upper clad layer 333 to be the saturable absorption region 311, and a gain region electrode (second electrode) 335 is formed on the front surface of the upper clad layer 333 to be the gain region 312. The reflective semiconductor optical amplifier 310 is based on a two-electrode semiconductor laser including the saturable absorption region electrode 334 and the gain region electrode 335. The optical amplifier element 300 including the reflective semiconductor optical amplifier 310 is mounted on the semiconductor substrate 200 by bonding the saturable absorption region electrode 334 and the gain region electrode 335 to the semiconductor substrate 200 by a solder bump and the like.

For example, a rear electrode is formed on a rear surface (highest surface in FIG. 25) of the lower clad layer 331, and is also grounded. A negative electrode of a constant voltage source (not illustrated) is connected to the saturable absorption region electrode 334, a reverse bias voltage is applied to the saturable absorption region electrode 334, and thus the saturable absorption region 311 is formed. A positive electrode of a constant current source (not illustrated) is connected to the gain region electrode 335, a constant current is injected into the gain region electrode 335, and thus the gain region 312 is formed. For example, the wavelength control unit 170 controls application of a reverse bias voltage to the saturable absorption region electrode 334 and injection of a constant current into the gain region electrode 335.

The external cavity 400 is a cavity that circulates light from the reflective semiconductor optical amplifier 310. As illustrated in FIG. 24, the external cavity 400 includes a broadband-pass filter 410, a multiplying filter 420, a cavity length adjustment optical waveguide 430, and a partial pass mirror 440. The external cavity 400 includes an optical waveguide 401 through which light from the reflective semiconductor optical amplifier 310 propagates and reciprocates. In the optical waveguide 401, the broadband-pass filter 410, the multiplying filter 420, the cavity length adjustment optical waveguide 430, and the partial pass mirror 440 are formed in series in an order from the reflective semiconductor optical amplifier 310 side to an output side of the light SO1.

The broadband-pass filter 410 passes light in a band needed for the multiwavelength light source from light generated by the mode-locked laser light source including the reflective semiconductor optical amplifier 310 and the external cavity 400. A gain band of the reflective semiconductor optical amplifier 310 is appropriately set broad, and the broadband-pass filter 410 passes light in a range narrower than the gain band of the reflective semiconductor optical amplifier 310. The broadband-pass filter 410 suppresses occurrence of unnecessary light. For example, the broadband-pass filter 410 may be formed of a lattice filter in which an asymmetric MZ interferometer is cascaded.

The multiplying filter 420 extracts light having a longitudinal mode spacing multiplied (n times) from the light generated by the mode-locked laser light source including the reflective semiconductor optical amplifier 310 and the external cavity 400. In other words, the multiplying filter 420 is a filter that multiplies a longitudinal mode spacing of the mode-locked laser light source by n times. For example, the multiplying filter 420 is a ring resonator filter in which an optical waveguide is circulated. A circulating length (optical length) of the multiplying filter 420 is an integral fraction of a cavity circulating length including the reflective semiconductor optical amplifier 310 and the external cavity 400.

A multiplying filter adjustment heater 421 is formed on (or above) the multiplying filter 420. The multiplying filter adjustment heater 421 may be formed under (or below) the multiplying filter 420. For example, the multiplying filter adjustment heater 421 is formed on the semiconductor substrate 200 including the multiplying filter 420, but may be disposed under the semiconductor substrate 200, or may be formed in the semiconductor substrate 200.

The multiplying filter adjustment heater 421 is a heat generator that can heat the multiplying filter 420. The multiplying filter adjustment heater 421 is formed of a resistor that can control a temperature, such as a TiN heater. The multiplying filter adjustment heater 421 may be formed in association with a region of the optical waveguide of the multiplying filter 420. The multiplying filter adjustment heater 421 may be formed in a region overlapping the entire optical waveguide of the multiplying filter 420, or may be formed in a region overlapping a part of the optical waveguide of the multiplying filter 420.

For example, the optical waveguide of the multiplying filter 420 is circulated in a rounded rectangle shape in a top view. The optical waveguide having the rounded rectangle shape includes optical waveguides 420a to 420d. The optical waveguide 420a is a directional coupler close to an optical waveguide linearly extending from the broadband-pass filter 410 (reflective semiconductor optical amplifier 310 side) to the output side of the light SO1. The optical waveguide 420b is a directional coupler that faces the optical waveguide 420a and is close to an optical waveguide linearly extending from the cavity length adjustment optical waveguide 430 (reflective semiconductor optical amplifier 310 side) to the output side of the light SO1. The optical waveguide 420c and the optical waveguide 420d face each other and extend linearly from both ends of the optical waveguide 420a and the optical waveguide 420b between the optical waveguide 420a and the optical waveguide 420b. For example, the multiplying filter adjustment heater 421 is formed in a region, which overlaps the optical waveguide 420c and the optical waveguide 420d, of the optical waveguide constituting the multiplying filter 420. In this example, the multiplying filter adjustment heater 421 is formed in a U shape in such a way as to overlap the optical waveguide 420c and the optical waveguide 420d. Note that the optical waveguide of the multiplying filter 420 is not limited to a rounded rectangle shape, and may circulate in a circular shape or an elliptic shape.

The multiplying filter adjustment heater 421 has one end grounded and the other end connected to the wavelength control unit 170. A multiplying filter heater current HT1 is injected from the wavelength control unit 170 into the other end of the multiplying filter adjustment heater 421. The multiplying filter adjustment heater 421 generates heat in response to the injected multiplying filter heater current HT1, a refractive index of the optical waveguide of the multiplying filter 420 is changed by heat of the multiplying filter adjustment heater 421, and thus a circulating length (optical length) of the multiplying filter 420 can be adjusted.

The cavity length adjustment optical waveguide 430 is an optical waveguide for adjusting a cavity length (optical length) of the entire mode-locked laser light source (multiwavelength light source 112) including the reflective semiconductor optical amplifier 310 and the external cavity 400. Note that adjusting a cavity length is also adjusting a cavity circulating length. For example, the cavity length adjustment optical waveguide 430 is an optical waveguide formed between the multiplying filter 420 and the partial pass mirror 440. The cavity length adjustment optical waveguide 430 adjusts a cavity length in such a way that a circulating length (optical length) of the multiplying filter 420 is an integral fraction of a cavity circulating length including the reflective semiconductor optical amplifier 310 and the external cavity 400.

A cavity length adjustment heater 431 is formed on (or above) the cavity length adjustment optical waveguide 430. The cavity length adjustment heater 431 may be formed under (or below) the cavity length adjustment optical waveguide 430. For example, the cavity length adjustment heater 431 is formed on the semiconductor substrate 200 including the cavity length adjustment optical waveguide 430, but may be disposed under the semiconductor substrate 200, or may be formed in the semiconductor substrate 200.

The cavity length adjustment heater 431 is a heat generator that can heat the cavity length adjustment optical waveguide 430. The cavity length adjustment heater 431 is formed of a resistor that can control a temperature, such as a TiN heater. The cavity length adjustment heater 431 is formed in association with a region of the cavity length adjustment optical waveguide 430. The cavity length adjustment heater 431 may be formed in a region overlapping the optical waveguide between the multiplying filter 420 and the partial pass mirror 440.

For example, the cavity length adjustment optical waveguide 430 is formed by being bent in a U shape in a top view between the multiplying filter 420 and the partial pass mirror 440. The cavity length adjustment optical waveguide 430 in the U shape includes optical waveguides 430a to 430c. The optical waveguide 430a linearly extends from the multiplying filter 420 (output side of the light SO1) to the reflective semiconductor optical amplifier 310 side. The optical waveguide 430b faces the optical waveguide 430a, and extends from the reflective semiconductor optical amplifier 310 side to the partial pass mirror 440 (output side of the light SO1). The optical waveguide 430c extends linearly from end portions on the reflective semiconductor optical amplifier 310 side of the optical waveguide 430a and the optical waveguide 430b between the optical waveguide 430a and the optical waveguide 430b. For example, the cavity length adjustment heater 431 is formed in a U shape in such a way as to overlap the optical waveguide 430a (for example, a part from the optical waveguide 430c to the multiplying filter 420), the optical waveguide 430b (for example, a part from the optical waveguide 430c to the partial pass mirror 440), and the optical waveguide 430c. The cavity length adjustment heater 431 may be formed in a region overlapping any of the optical waveguides 430a to 430c.

The cavity length adjustment heater 431 has one end grounded and the other end connected to the wavelength control unit 170. A cavity length adjustment heater current HT2 is injected from the wavelength control unit 170 into the other end of the cavity length adjustment heater 431. The cavity length adjustment heater 431 generates heat in response to the injected cavity length adjustment heater current HT2, a refractive index of the cavity length adjustment optical waveguide 430 is changed by heat of the cavity length adjustment heater 431, and thus an optical length (i.e., a cavity length) of the cavity length adjustment optical waveguide 430 can be adjusted.

The partial pass mirror 440 reflects a part of light from the cavity length adjustment optical waveguide 430, and passes (outputs) a remaining part of the light as the light SO1. For example, the partial pass mirror 440 is a Sagnac waveguide mirror. The partial pass mirror 440 is formed on an end surface on an output side of the external cavity 400.

The mode-locked laser light source (multiwavelength light source 112) including the reflective semiconductor optical amplifier 310 and the external cavity 400 causes light to circulate between the reflective end surface 322 of the reflective semiconductor optical amplifier 310 and the partial pass mirror 440. An optical length between the reflective end surface 322 of the reflective semiconductor optical amplifier 310 and the partial pass mirror 440 (center of the mirror) is a cavity length of the entire mode-locked laser light source. In order for the mode-locked laser light source to output the light SO1 having a wavelength spacing multiplied by the multiplying filter 420, a cavity length (optical length) Lt of the mode-locked laser light source and a circulating length (optical length) L_{ring} of the multiplying filter 420 need to satisfy the following relationship.

$${L}_{t} = {L}_{ring} \cdot n / 2 ( n : positive integer ) \qquad ( 1 )$$

When Equation (1) is transformed, the circulating length L_{ring} of the multiplying filter 420 is expressed as follows. In other words, as described above, the circulating length L_{ring} of the multiplying filter 420 is an integral fraction of a cavity circulating length 2Lₜ.

$${L}_{ring} = 2 {L}_{t} / n ( n : positive integer ) \qquad ( 2 )$$

In the present example embodiment, the multiplying filter heater current HT1 and the cavity length adjustment heater current HT2 are adjusted, and a circulating length of the multiplying filter 420 and a cavity length (cavity circulating length) are adjusted, in such a way as to satisfy the relationship of Equation (1) or Equation (2).

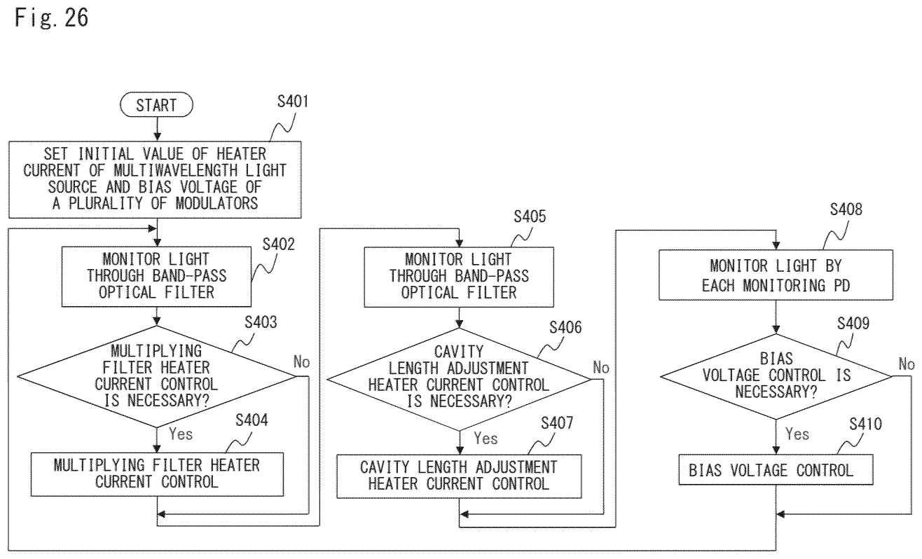

FIG. 26 illustrates an operation example of the optical transmitter 1 according to some example embodiments. In the example in FIG. 26, first, the optical transmitter 1 sets an initial value of the heater current HT of the multiwavelength light source 112 and the bias voltage BS of the plurality of DP-IQ modulators 220 (S401).

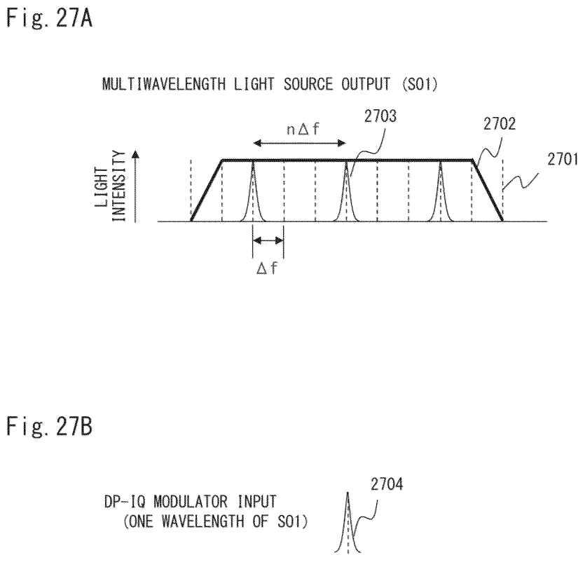

FIGS. 27A-27C illustrate examples of each optical signal at an initial setting time, and examples of one wavelength of the light SO1, which is a multiwavelength light, being output from the multiwavelength light source 112 and the light SO1 being input to the DP-IQ modulator 220, and a spectrum of a monitoring optical signal SO4 being input to the band-pass optical filter 140.

The wavelength control unit 170 applies a reverse bias voltage to the saturable absorption region electrode 334, and injects a constant current into the gain region electrode 335. Then, as indicated by 2701 in FIG. 27A, the multiwavelength light source 112 generates light at a longitudinal mode spacing (Δf) of an external cavity length by an external cavity mode-locked operation. Next, as indicated by 2702 in FIG. 27A, the broadband-pass filter 410 passes light included in a band of a band-pass filter characteristic of the broadband-pass filter 410 from the generated light at the longitudinal mode spacing (Δf). Next, as indicated by 2703 in FIG. 27A, the multiplying filter 420 extracts light at a spacing n-times the light at the longitudinal mode spacing (Δf) passing through the broadband-pass filter 410. The partial pass mirror 440 outputs the multiwavelength light at a spacing of nΔf as the light SO1.

The wavelength demultiplexer 113 demultiplexes, for each wavelength, the light SO1, which is the multiwavelength light, being output from the multiwavelength light source 112, and, for example, inputs one wavelength of the branched light SO1 to the DP-IQ modulator 220-N as in 2704 in FIG. 27B. The DP-IQ modulator 220-N modulates one wavelength of the light SO1. The demultiplexer 130-N branches a modulated optical signal SO2 being modulated, and inputs the branched monitoring optical signal SO4 to the band-pass optical filter 140. As in 2705 in FIG. 27C, in a case of no wavelength deviation in an initial state, the center of a spectrum of the monitoring optical signal SO4 coincides with the center of a passband spectrum of the band-pass optical filter 140. The monitoring PD 150-N monitors light passing through the band-pass optical filter 140.

The wavelength control unit 170 adjusts the multiplying filter heater current HT1 and the cavity length adjustment heater current HT2 in such a way that the cavity length Lₜ (or the cavity circulating length 2Lₜ) of the multiwavelength light source 112 and the circulating length L_{ring} of the multiplying filter 420 maintain the relationship of Equation (1) or Equation (2) described above. In a case where the cavity length Lₜ (or the cavity circulating length 2Lₜ) of the multiwavelength light source 112 and the circulating length L_{ring} of the multiplying filter 420 satisfy the relationship of Equation (1) or Equation (2) described above, multiwavelength light at the spacing of nΔf is normally output from the multiwavelength light source 112, and thus monitoring power of the monitoring signal MO is maximum. Thus, the wavelength control unit 170 adjusts the multiplying filter heater current HT1 and the cavity length adjustment heater current HT2 in such a way that the monitoring power of the monitoring signal MO monitored by the monitoring PD 150 is maximum, and thus sets a relationship between the cavity length Lₜ (or the cavity circulating length 2Lₜ) of the multiwavelength light source 112 and the circulating length L_{ring} of the multiplying filter 420 to be the relationship of Equation (1) or Equation (2) described above. The wavelength control unit 170 sets, as an initial value, the multiplying filter heater current HT1 and the cavity length adjustment heater current HT2 in a case where the monitoring power of the monitoring signal MO is maximum.

Furthermore, the bias control unit 160 modulates each wavelength of the light SO1, which is the multiwavelength light, by the DP-IQ modulators 220-1 to 220-N, adjusts the bias voltage BS of the DP-IQ modulators 220-1 to 220-N, based on the monitoring signal MO monitored by the monitoring PDs 150-1 to 150-N, and sets the adjusted bias voltage BS as an initial value.

Next, the optical transmitter 1 performs wavelength control processing of the multiwavelength light source 112 (S402 to S407). The wavelength control processing of the multiwavelength light source 112 includes multiplying filter heater current control processing (S402 to S404) and cavity length adjustment heater current control processing (S405 to S407).

In the multiplying filter heater current control processing, the monitoring PD 150-N monitors light through the band-pass optical filter 140 (S402). Specifically, the wavelength demultiplexer 113 demultiplexes the light SO1, which is the multiwavelength light, from the multiwavelength light source 112, and the DP-IQ modulator 220-N modulates an optical signal demultiplexed from the light SO1 which is the multiwavelength light. The demultiplexer 130-N branches the modulated optical signal SO2 modulated by the DP-IQ modulator 220-N into an output optical signal SO3 and the monitoring optical signal SO4. The band-pass optical filter 140 passes light in a passband of the branched monitoring optical signal SO4. The monitoring PD 150-N detects an optical signal through the band-pass optical filter 140, and converts the detected optical signal into a monitoring current (monitoring signal MO).

Next, the wavelength control unit 170 determines whether control (adjustment) of the multiplying filter heater current HT1 is necessary, based on a monitoring result of the monitoring PD 150 (S403). For example, the wavelength control unit 170 determines whether the monitoring current (monitoring signal MO) output from the monitoring PD 150 is equal to or less than a predetermined threshold value (a threshold value for determining adjustment to a multiplying filter heater current), and determines control of the multiplying filter heater current HT1 necessary in a case where the monitoring current is equal to or less than the predetermined threshold value.

Next, in a case where control of the multiplying filter heater current HT1 is determined necessary, the wavelength control unit 170 controls (adjusts) the multiplying filter heater current HT1 (S404). The wavelength control unit 170 adjusts the multiplying filter heater current HT1 according to the detected monitoring current, and injects the adjusted multiplying filter heater current HT1 to the multiplying filter adjustment heater 421. For example, the wavelength control unit 170 repeats adjustment to the multiplying filter heater current HT1 until the monitoring current exceeds the predetermined threshold value.

Subsequent to the multiplying filter heater current control processing, the cavity length adjustment heater current control processing is performed. In the cavity length heater current control processing, similarly to S402, the monitoring PD 150-N monitors light through the band-pass optical filter 140 (S405).

Next, the wavelength control unit 170 determines whether control (adjustment) of the cavity length adjustment heater current HT2 is necessary, based on a monitoring result of the monitoring PD 150 (S406). For example, the wavelength control unit 170 determines whether the monitoring current (monitoring signal MO) output from the monitoring PD 150 is equal to or less than a predetermined threshold value (a threshold value for determining adjustment to a cavity length adjustment heater current), and determines control of the cavity length adjustment heater current HT2 necessary in a case where the monitoring current is equal to or less than the predetermined threshold value.

Next, in a case where control of the cavity length adjustment heater current HT2 is determined necessary, the wavelength control unit 170 controls (adjusts) the cavity length adjustment heater current HT2 (S407). The wavelength control unit 170 adjusts the cavity length adjustment heater current HT2 according to the detected monitoring current, and injects the adjusted cavity length adjustment heater current HT2 to the cavity length adjustment heater 431. For example, the wavelength control unit 170 repeats adjustment to the cavity length adjustment heater current HT2 until the monitoring current exceeds the predetermined threshold value. By the multiplying filter heater current control processing and the cavity length adjustment heater current control processing, the multiplying filter heater current HT1 and the cavity length adjustment heater current HT2 can be adjusted in such a way that a cavity length of the multiwavelength light source and a circulating length of the multiplying filter maintain a predetermined relationship. By adjusting a circulating length of the multiplying filter 420 by adjusting the multiplying filter heater current HT1, and then adjusting a cavity length by adjusting the cavity length adjustment heater current HT2, a wavelength of the multiwavelength light source can be accurately adjusted.

In the multiplying filter heater current control processing and the cavity length adjustment heater current control processing, each heater current may be controlled similarly to the examples in FIGS. 13 and 14. In other words, in a case where the monitoring power of the monitoring signal MO is decreased by equal to or more than a designated value, the multiplying filter heater current HT1 may be adjusted according to a shift amount of the monitoring power when the multiplying filter heater current HT1 is increased and decreased. In a case where the monitoring power of the monitoring signal MO is decreased by equal to or more than a designated value, the cavity length adjustment heater current HT2 may be adjusted according to a shift amount of the monitoring power when the cavity length adjustment heater current HT2 is increased and decreased.

Subsequent to the multiplying filter heater current control processing and the cavity length adjustment heater current control processing, bias control processing of the plurality of DP-IQ modulators 220 is performed (S408 to S410). The bias control processing is processing in which the processing in S105 to S107 in FIG. 9 is applied to bias control of a plurality of modulators.

In other words, in the bias control processing, the monitor PDs 150-1 to 150-N monitor the monitoring signal MO being branched and modulated by the DP-IQ modulators 220-1 to 220-N (S408). The bias control unit 160 determines whether bias control (adjustment) of the DP-IQ modulators 220-1 to 220-N is necessary, based on a monitoring result of the monitoring PDs 150-1 to 150-N (S409). In a case where bias control is determined necessary, the bias control unit 160 controls (adjusts) the bias voltage BS of the corresponding DP-IQ modulator 220 (S410).

In the bias control processing, a bias voltage may be controlled similarly to the examples in FIGS. 15 and 16. In other words, for each of the DP-IQ modulators 220, in a case where an objective function value of the monitoring signal MO is increased by equal to or more than a designated value, the bias voltage BS may be adjusted according to a shift amount of the objective function value when the bias voltage BS is increased and decreased.

As described above, the optical transmitter may include the plurality of DP-IQ modulators and the multiwavelength light source.

Also, in this case, the plurality of DP-IQ modulators, the multiwavelength light source, and the like can be integrated, and bias control and wavelength control can be suitably performed, similarly to the first example embodiment. A wavelength deviation of multiwavelength light can be collectively adjusted by adjusting a heater current of the multiwavelength light source. By adjusting the multiplying filter heater current and the cavity length adjustment heater current of the mode-locked laser, a wavelength deviation of the multiwavelength light can be accurately adjusted.

Note that the present disclosure is not limited to the example embodiments described above, and may be appropriately modified without departing from the scope of the present disclosure.

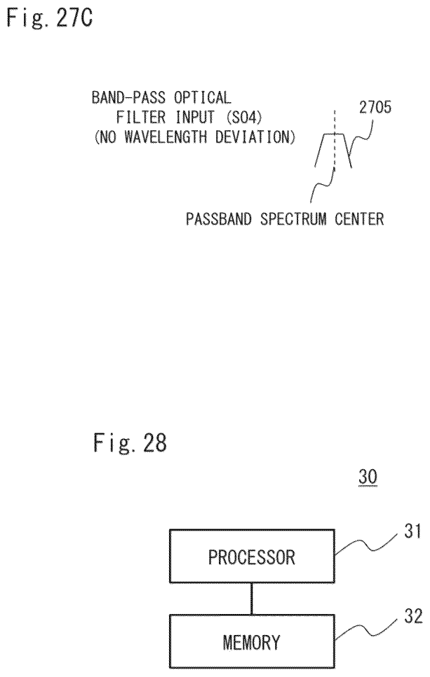

Each configuration in the example embodiments described above is formed of hardware, software, or both, and may be formed of one piece of hardware or one piece of software, or may be formed of a plurality of pieces of hardware or a plurality of pieces of software. Each function (processing) such as the bias control unit and the wavelength control unit may be achieved by a computer 30 including a processor 31 such as a central processing unit (CPU) and a memory 32 being a storage device as illustrated in FIG. 28. For example, a program for performing a method (control method) in the example embodiment may be stored in the memory 32, and each function may be achieved by executing the program stored in the memory 32 by the processor 31.

When the program is read by a computer, the program includes a command group (or software codes) for causing the computer to perform one or more of the functions described in the example embodiments. The program may be stored in a non-transitory computer-readable medium or a tangible storage medium. Examples of the computer-readable medium or the tangible storage medium include a random-access memory (RAM), a read-only memory (ROM), a flash memory, a solid-state drive (SSD), or other memory technique, a CD-ROM, a digital versatile disc (DVD), a Blu-ray (registered trademark) disc, or other optical disc storage, a magnetic cassette, a magnetic tape, a magnetic disc storage, or other magnetic storage device, which are not limited thereto. The program may be transmitted on a transitory computer-readable medium or a communication medium. Examples of the transitory computer-readable medium or the communication medium include electrical, optical, acoustic, or other form of propagation signals, which are not limited thereto.

Although the present disclosure has been described above with reference to the example embodiments, the present disclosure is not limited to the above-described example embodiments. Various modifications that can be understood by those skilled in the art can be made to the configuration and the details of the present disclosure within the scope of the present disclosure. Then, each of the example embodiments can be appropriately combined with the other example embodiment.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures may be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

A part or the whole of the example embodiments described above can be described as, but not limited to, the following supplementary notes.

### (Supplementary Note 1)

An optical transmitter including:
a mode-locked laser light source configured to generate a multiwavelength light;
a plurality of semiconductor modulators configured to modulate, for each wavelength, the generated multiwavelength light from the mode-locked laser light source into modulated light;
an optical filter configured to pass light in a passband from modulated light being modulated by a first semiconductor modulator among the plurality of semiconductor modulators;
an optical monitor configured to monitor the passed light;
a wavelength control means for controlling a wavelength of the multiwavelength light from the mode-locked laser light source, based on the monitored result; and
a bias control means for controlling a bias voltage of the first semiconductor modulator, based on the monitoring result, wherein
the mode-locked laser light source includes
   a reflective semiconductor optical amplifier configured to emit light,
   an external cavity being configured to circulate light from the reflective semiconductor optical amplifier, and including a multiplying filter configured to multiply a longitudinal mode spacing of the mode-locked laser light source, and
   a multiplying filter adjustment heater configured to be able to heat the multiplying filter, and
the wavelength control means controls a wavelength of the multiwavelength light from the mode-locked laser light source by controlling a heater current injected into the multiplying filter adjustment heater.

### (Supplementary Note 2)

The optical transmitter according to supplementary note 1, wherein
the external cavity includes a cavity length adjustment optical waveguide configured to adjust a cavity length including the reflective semiconductor optical amplifier and the external cavity,
the mode-locked laser light source includes a cavity length adjustment heater configured to be able to heat the cavity length adjustment optical waveguide, and
the wavelength control means controls a wavelength of the multiwavelength light from the mode-locked laser light source by controlling a heater current injected into the multiplying filter adjustment heater and the cavity length adjustment heater.

### (Supplementary Note 3)

The optical transmitter according to supplementary note 2, wherein
the multiplying filter is a ring resonator filter, and
the wavelength control means controls a heater current injected into the multiplying filter adjustment heater and the cavity length adjustment heater in such a way that a circulating length of the multiplying filter is an integral fraction of a cavity circulating length including the reflective semiconductor optical amplifier and the external cavity.

### (Supplementary Note 4)

The optical transmitter according to any one of supplementary notes 1 to 3, wherein the wavelength control means controls the heater current according to whether power of the monitored light is decreased from an initial value by equal to or more than a predetermined designated value.

### (Supplementary Note 5)

The optical transmitter according to supplementary note 4, wherein, in a case where the power of the monitored light is decreased from the initial value by equal to or more than the predetermined designated value, the wavelength control means controls the heater current according to a shift amount of the power of the monitored light in a case where the heater current is increased and decreased.

### (Supplementary Note 6)

The optical transmitter according to supplementary note 5, wherein the wavelength control means controls the heater current according to an increase or a decrease in the power of the monitored light in a case where the heater current is increased, and an increase or a decrease in the power of the monitored light in a case where the heater current is decreased.

### (Supplementary Note 7)

The optical transmitter according to supplementary note 1, wherein the bias control means controls the bias voltage according to whether an objective function value acquired by converting power of the monitored light is increased from an initial value by equal to or more than a predetermined designated value.

### (Supplementary Note 8)

The optical transmitter according to supplementary note 7, wherein, in a case where the objective function value based on the power of the monitored light is increased from the initial value by equal to or more than the predetermined designated value, the bias control means controls the bias voltage according to a shift amount of the objective function value based on the power of the monitored light in a case where the bias voltage is increased and decreased.

### (Supplementary Note 9)

The optical transmitter according to supplementary note 8, wherein the bias control means controls the bias voltage according to an increase or a decrease in the objective function value based on the power of the monitored light in a case where the bias voltage is increased, and an increase or a decrease in the objective function value based on the power of the monitored light in a case where the bias voltage is decreased.

### (Supplementary Note 10)

A method for controlling an optical transmitter including:
generating a multiwavelength light by a mode-locked laser light source;
modulating, for each wavelength, the generated multiwavelength light from the mode-locked laser light source into modulated light by a plurality of semiconductor modulators;
passing light in a passband from modulated light being modulated by a first semiconductor modulator among the plurality of semiconductor modulators;
monitoring the passed light;
controlling a wavelength of the multiwavelength light from the mode-locked laser light source, based on the monitored result;
controlling a bias voltage of the first semiconductor modulator, based on the monitored result;
in the mode-locked laser light source,
emitting light by a reflective semiconductor optical amplifier; and
in an external cavity configured to circulate light from the reflective semiconductor optical amplifier, multiplying a longitudinal mode spacing of the mode-locked laser light source by a multiplying filter,
wherein controlling the wavelength includes controlling a wavelength of the multiwavelength light from the mode-locked laser light source by controlling a heater current injected into a multiplying filter adjustment heater configured to be able to heat the multiplying filter.

### (Supplementary Note 11)

An optical transmitter including:
a light source configured to generate light;
a heater configured to be able to heat the light source;
a semiconductor modulator configured to modulate the generated light from the light source into modulated light;
an optical filter configured to pass light in a passband from the modulated light being modulated;
an optical monitor configured to monitor the passed light;
a wavelength control means for controlling a wavelength of the light from the light source by controlling a heater current injected into the heater, based on the monitored result; and
a bias control means for controlling a bias voltage of the semiconductor modulator, based on the monitored result,
wherein the wavelength control means controls the heater current according to whether power of the monitored light is decreased from an initial value by equal to or more than a predetermined designated value.

### (Supplementary Note 12)

The optical transmitter according to supplementary note 11, wherein, in a case where the power of the monitored light is decreased from the initial value by equal to or more than the predetermined designated value, the wavelength control means controls the heater current according to a shift amount of the power of the monitored light in a case where the heater current is increased and decreased.

### (Supplementary Note 13)

The optical transmitter according to supplementary note 12, wherein the wavelength control means controls the heater current according to an increase or a decrease in the power of the monitored light in a case where the heater current is increased, and an increase or a decrease in the power of the monitored light in a case where the heater current is decreased.

### (Supplementary Note 14)

An optical transmitter including:
a light source configured to generate light;
a heater configured to be able to heat the light source;
a semiconductor modulator configured to modulate the generated light from the light source into modulated light;
an optical filter configured to pass light in a passband from the modulated light being modulated;
an optical monitor configured to monitor the passed light;
a wavelength control means for controlling a wavelength of the light from the light source by controlling a heater current injected into the heater, based on the monitored result; and
a bias control means for controlling a bias voltage of the semiconductor modulator, based on the monitored result,
wherein the bias control means controls the bias voltage according to whether an objective function value acquired by converting power of the monitored light is increased from an initial value by equal to or more than a predetermined designated value.

### (Supplementary Note 15)

The optical transmitter according to supplementary note 14, wherein, in a case where the objective function value based on the power of the monitored light is increased from the initial value by equal to or more than the predetermined designated value, the bias control means controls the bias voltage according to a shift amount of the objective function value based on the power of the monitored light in a case where the bias voltage is increased and decreased.

### (Supplementary Note 16)

The optical transmitter according to supplementary note 15, wherein the bias voltage control means controls the bias voltage according to an increase or a decrease in the objective function value based on the power of the monitored light in a case where the bias voltage is increased, and an increase or a decrease in the objective function value based on the power of the monitored light in a case where the bias voltage is decreased.

### (Supplementary Note 17)

A method for controlling an optical transmitter including:
generating light by a light source;
modulating the generated light from the light source into modulated light by a semiconductor modulator;
passing light in a passband from the modulated light being modulated;
monitoring the passed light;
controlling a wavelength of the light from the light source by controlling a heater current injected into a heater configured to be able to heat the light source, based on the monitored result; and
controlling a bias voltage of the semiconductor modulator, based on the monitored result,
wherein controlling the wavelength includes controlling the heater current according to whether power of the monitored light is decreased from an initial value by equal to or more than a predetermined designated value.

### (Supplementary Note 18)

A method for controlling an optical transmitter including:
generating light by a light source;
modulating the generated light from the light source into modulated light by a semiconductor modulator;
passing light in a passband from the modulated light being modulated;
monitoring the passed light;
controlling a wavelength of the light from the light source by controlling a heater current injected into a heater configured to be able to heat the light source, based on the monitored result; and
controlling a bias voltage of the semiconductor modulator, based on the monitored result,
wherein controlling the bias control includes controlling the bias voltage according to whether an objective function value acquired by converting power of the monitored light is increased from an initial value by equal to or more than a predetermined designated value.

A part or the whole of the elements (for example, the configuration and the functions) described in supplementary note 2 to supplementary note 9 subordinate to the optical transmitter in supplementary note 1 may also be subordinate to the method for controlling an optical transmitter in supplementary note 10 in a subordinate relationship similar to supplementary note 2 to supplementary note 9. A part or the whole of the elements (for example, the configuration and the functions) described in supplementary note 12 to supplementary note 13 subordinate to the optical transmitter in supplementary note 11 may also be subordinate to the method for controlling an optical transmitter in supplementary note 17 in a subordinate relationship similar to supplementary note 12 to supplementary note 13. A part or the whole of the elements (for example, the configuration and the functions) described in supplementary note 15 to supplementary note 16 subordinate to the optical transmitter in supplementary note 14 may also be subordinate to the method for controlling an optical transmitter in supplementary note 18 in a subordinate relationship similar to supplementary note 15 to supplementary note 16. A part or the whole of the elements described in any supplementary note may be applied to various types of hardware, software, recording means for recording software, systems, and methods.

What is claimed is:

1. An optical transmitter comprising:
a mode-locked laser light source configured to generate a multiwavelength light;
a plurality of semiconductor modulators configured to modulate, for each wavelength, the generated multiwavelength light from the mode-locked laser light source into modulated light;
an optical filter configured to pass light in a passband from modulated light being modulated by a first semiconductor modulator among the plurality of semiconductor modulators;
an optical monitor configured to monitor the passed light;
a wavelength controller configured to control a wavelength of the multiwavelength light from the mode-locked laser light source, based on the monitored result; and
a bias controller configured to control a bias voltage of the first semiconductor modulator, based on the monitored result, wherein
the mode-locked laser light source includes
a reflective semiconductor optical amplifier configured to emit light,
an external cavity being configured to circulate light from the reflective semiconductor optical amplifier, and including a multiplying filter configured to multiply a longitudinal mode spacing of the mode-locked laser light source, and
a multiplying filter adjustment heater configured to be able to heat the multiplying filter, and
the wavelength controller controls a wavelength of the multiwavelength light from the mode-locked laser light source by controlling a heater current injected into the multiplying filter adjustment heater.

2. The optical transmitter according to claim 1, wherein
the external cavity includes a cavity length adjustment optical waveguide configured to adjust a cavity length including the reflective semiconductor optical amplifier and the external cavity,
the mode-locked laser light source includes a cavity length adjustment heater configured to be able to heat the cavity length adjustment optical waveguide, and
the wavelength controller controls a wavelength of the multiwavelength light from the mode-locked laser light source by controlling a heater current injected into the multiplying filter adjustment heater and the cavity length adjustment heater.

3. The optical transmitter according to claim 2, wherein
the multiplying filter is a ring resonator filter, and
the wavelength controller controls a heater current injected into the multiplying filter adjustment heater and the cavity length adjustment heater in such a way that a circulating length of the multiplying filter is an integral fraction of a cavity circulating length including the reflective semiconductor optical amplifier and the external cavity.

4. The optical transmitter according to claim 1, wherein the wavelength controller controls the heater current according to whether power of the monitored light is decreased from an initial value by equal to or more than a predetermined designated value.

5. The optical transmitter according to claim 4, wherein, in a case where the power of the monitored light is decreased from the initial value by equal to or more than the predetermined designated value, the wavelength controller controls the heater current according to a shift amount of the power of the monitored light in a case where the heater current is increased and decreased.

6. The optical transmitter according to claim 5, wherein the wavelength controller controls the heater current according to an increase or a decrease in the power of the monitored light in a case where the heater current is increased, and an increase or a decrease in the power of the monitored light in a case where the heater current is decreased.

7. The optical transmitter according to claim 1, wherein the bias controller controls the bias voltage according to whether an objective function value acquired by converting power of the monitored light is increased from an initial value by equal to or more than a predetermined designated value.

8. The optical transmitter according to claim 7, wherein, in a case where the objective function value based on the power of the monitored light is increased from the initial value by equal to or more than the predetermined designated value, the bias controller controls the bias voltage according to a shift amount of the objective function value based on the power of the monitored light in a case where the bias voltage is increased and decreased.

9. The optical transmitter according to claim 8, wherein the bias controller controls the bias voltage according to an increase or a decrease in the objective function value based on the power of the monitored light in a case where the bias voltage is increased, and an increase or a decrease in the objective function value based on the power of the monitored light in a case where the bias voltage is decreased.

10. A method for controlling an optical transmitter comprising:
generating a multiwavelength light by a mode-locked laser light source;
modulating, for each wavelength, the generated multiwavelength light from the mode-locked laser light source into modulated light by a plurality of semiconductor modulators;
passing light in a passband from modulated light being modulated by a first semiconductor modulator among the plurality of semiconductor modulators;
monitoring the passed light;
controlling a wavelength of the multiwavelength light from the mode-locked laser light source, based on the monitored result;
controlling a bias voltage of the first semiconductor modulator, based on the monitored result;
in the mode-locked laser light source,
emitting light by a reflective semiconductor optical amplifier; and
in an external cavity configured to circulate light from the reflective semiconductor optical amplifier, multiplying a longitudinal mode spacing of the mode-locked laser light source by a multiplying filter,
wherein controlling the wavelength includes controlling a wavelength of the multiwavelength light from the mode-locked laser light source by controlling a heater current injected into a multiplying filter adjustment heater configured to be able to heat the multiplying filter.

11. An optical transmitter comprising:
a light source configured to generate light;
a heater configured to be able to heat the light source;
a semiconductor modulator configured to modulate the generated light from the light source into modulated light;
an optical filter configured to pass light in a passband from the modulated light being modulated;
an optical monitor configured to monitor the passed light;
a wavelength controller configured to control a wavelength of the light from the light source by controlling a heater current injected into the heater, based on the monitored result; and
a bias controller configured to control a bias voltage of the semiconductor modulator, based on the monitored result,
wherein the wavelength controller controls the heater current according to whether power of the monitored light is decreased from an initial value by equal to or more than a predetermined designated value.

12. The optical transmitter according to claim 11, wherein, in a case where the power of the monitored light is decreased from the initial value by equal to or more than the predetermined designated value, the wavelength controller controls the heater current according to a shift amount of the power of the monitored light in a case where the heater current is increased and decreased.

13. The optical transmitter according to claim 12, wherein the wavelength controller controls the heater current according to an increase or a decrease in the power of the monitored light in a case where the heater current is increased, and an increase or a decrease in the power of the monitored light in a case where the heater current is decreased.
